(19) United States
(12) Patent Application Publication
(10) Pub. No.: US 2026/0077304 A1
(43) Pub. Date: Mar. 19, 2026

(54) ELECTRICALLY CONDUCTIVE INTERCONNECT RIBS FOR A CERAMIC OXYGEN PURIFIER

(71) Applicant: American Oxygen, LLC, Salt Lake City, UT (US)

(72) Inventors: Dale M. Taylor, Murray, UT (US); Thomas D. Taylor, Bountiful, UT (US); Zhipeng Nan, Sandy, UT (US)

(73) Assignee: American Oxygen, LLC, Salt Lake City, UT (US)

(21) Appl. No.: 19/329,470

(22) Filed: Sep. 15, 2025

Related U.S. Application Data
(60) Provisional application No. 63/694,700, filed on Sep. 13, 2024.

(51) Int. Cl. B01D 53/32

(52) U.S. Cl. CPC B01D 53/326; B01D 2256/12

(57) ABSTRACT

Systems for oxygen concentration and pressurization. An assembly includes a first ceramic wafer comprising a porous cathode and a second ceramic wafer comprising an anode cap. The assembly includes an interconnect disposed in between the first ceramic wafer and the second ceramic wafer. The assembly is such that the interconnect is attached to the porous cathode of the first ceramic wafer and is further attached to the anode cap of the second ceramic wafer. The assembly is such that the interconnect comprises a through-porosity that enables an oxygen-containing gas to pass through the interconnect or diffuse into the interconnect.

### CROSS-REFERENCE TO RELATED APPLICATIONS

This application claims the benefit of U.S. Provisional Patent Application No. 63/694,700, filed Sep. 13, 2024, entitled “CERAMIC OXYGEN GENERATOR,” which is incorporated herein by reference in its entirety, including but not limited to those portions that specifically appear hereinafter, the incorporation by reference being made with the following exception: In the event that any portion of the above-referenced provisional application is inconsistent with this application, this application supersedes the above-referenced provisional application.

### TECHNICAL FIELD

The disclosure relates generally to the concentration, purification, and pressurization of oxygen gas and more particularly relates to ceramic devices for concentrating oxygen gas.

### BACKGROUND

Many industries and applications benefit from oxygen gas or purified oxygen gas 108. Common uses of oxygen gas are in the medical field, in commercial applications, in industrial manufacturing and construction applications, in chemical manufacturing applications, and so forth. Purified oxygen gas 108 serves a key role in many different industries. However, traditional methods for purifying oxygen are time, resource, and energy intensive. It is therefore desirable to develop systems, methods, and devices for purifying oxygen by way of low cost and low energy means.

Oxygen is the only element that supports respiration, and it is required to support life and maintain healthy biological processes. Because oxygen is imperative to life and health, separated oxygen and/or purified oxygen gas 108 is commonly used in medical applications. For example, medical oxygen is used as a basis for virtually all procedures that involve the use of anesthesia, medical oxygen is typically provided to all patients that are experiencing any respiratory distress, and all patients experiencing low blood oxygen levels. Providing purified oxygen gas 108 to a patient can restore the patient's tissue oxygen tension by improving oxygen availability in a wide range of conditions, including cyanosis, shock, sever hemorrhage, carbon monoxide poisoning, major trauma, cardiac arrest, and respiratory arrest. Oxygen can aid in resuscitation of a patient and provides a vital role in sustaining the patient's brain function and tissue health during a time of distress. Hospitals and clinics around the world need a constant ready-to-use supply of purified oxygen gas that can be provided to a patient at any time. Many hospitals, particularly smaller hospitals, or remote hospitals, rely on using individual tanks of oxygen gas. This can be extremely expensive and can be a significant financial burden on some medical facilities. In addition, as oxygen in the tanks are consumed, they must be refilled or replaced with pre-filled tanks, and this creates a risk a given medical facility will run out of their stored oxygen supply. This risk is particularly acute during inclement weather or after a local disaster such as a hurricane, earthquake, flooding, mudslide, forest fire, or other disaster when medical oxygen supplies are most needed. Therefore, it is desirable to provide systems, methods, and devices for generating purified oxygen on-site or near the consumer at a lower cost that is sustainable and requires less energy to produce and maintain and is less susceptible to environmental conditions.

Other important industries that rely on the use of purified oxygen gas 108 include a wide range of industrial manufacturing industries such as chemical manufacturing, raw material refinement, and others. Many manufacturing processes benefit from oxygen enrichment. For example, processes involving combustion are greatly improved by lowering the amount of nitrogen gas and increasing the amount of oxygen gas. The combustion efficiencies will increase due to a drop in heat loss as a result of lower mass flow rates. Further for example, processes involving gasification by which coal, or another carbon-based fuel, is transformed into a synthesis gas, benefit from oxygen enrichment. Therefore, it is desirable to provide low-cost and high efficiency means for generating copious quantities of oxygen gas for use across many different industries.

One traditional method of generating oxygen gas is by way of cryogenic air separation. Historically, this method accounts for over 95% of all oxygen production and is performed at a central production plant and then distributed to end users. Cryogenic air separation is used to produce concentrated oxygen or nitrogen in high volumes. Air is commonly made up of oxygen, nitrogen, argon, carbon dioxide, water vapor, and other particles. Cryogenic air separation is based on each of these components having a different boiling point, i.e., when the component transitions from a liquid state to a gaseous state. In cryogenic air separation, the temperature of air is lowered so that nitrogen and oxygen separate based on their different boiling points. This occurs at around −300° F. If purified oxygen gas 108 is desired, then further distillation is required. Because the air must be lowered to an extremely cold temperature, cryogenic air separation is expensive in terms of money and energy resources. Further, because cryogenic air separation occurs at large production plants and must then be transported by way of cryogenic vessels or pressurized vessels, this method consumes enormous sums of energy and can be expensive for end users.

Another method of generating oxygen gas is by way of pressure swing adsorption. Pressure swing adsorption consumes air into a pressurized tank having zeolites. The zeolites, under pressure, create a dipole that allows for the collection of nitrogen and allows oxygen to pass. Pressure swing adsorption is not well suited for processes that require purified oxygen gas 108, such as gas that is 95% or more oxygen. In some implementations, multi-stage pressure swing adsorption is capable of generating purified oxygen gas 108, but the cost is tremendously high, and it is not a desirable process to perform. Pressure swing adsorption can be implemented on-site by an end user, but it cannot produce high purity or ultra-purified oxygen gas 108 without an enormous increase in cost. This method is typically used for low purity applications with an oxygen concentration of 93% or less.

In view of the foregoing, disclosed herein are systems, methods, and devices for improved oxygen concentration and pressurization.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 is a schematic illustration of a system for oxygen concentration and pressurization;

FIG. 2 is a perspective view of a stack assembly for outputting purified oxygen gas, wherein the stack assembly includes an electrochemical stack and a terminal plumbing assembly;

FIG. 3 is a straight-on side view of a stack assembly for outputting purified oxygen gas, wherein the stack assembly includes an electrochemical stack and a terminal plumbing assembly;

FIG. 4 is a perspective view of a terminal plumbing assembly that couples an output tube to an electrochemical stack while compensating for a differential in coefficients of thermal expansion (CTEs) between the metal tube and the ceramic electrochemical stack;

FIG. 5 is a cross-sectional straight-on side view of a terminal plumbing assembly that couples an output tube to an electrochemical stack while compensating for a differential in coefficients of thermal expansion (CTEs) between the metal tube and the ceramic electrochemical stack;

FIG. 6 is a cross-sectional straight-on side view of an assembly comprising a terminal plumbing assembly that couples an output tube to an electrochemical stack while compensating for a differential in coefficients of thermal expansion (CTEs) between the metal tube and the ceramic electrochemical stack;

FIG. 7 is a cross-sectional straight-on side view of a manufacturing assembly for creating a metal-ceramic seal with a terminal plumbing assembly;

FIG. 8 is a schematic illustration of a straight-on side view of metal components of a terminal plumbing assembly;

FIG. 9 is a schematic illustration of a cross-sectional straight-on side view of a ceramic adapter of a terminal plumbing assembly;

FIG. 10 is an exploded perspective view of a wafer-spacer assembly;

FIG. 11 is a perspective view of a wafer-spacer assembly;

FIG. 12 is a schematic illustration of an aerial top-down view of a wafer assembly including a wafer, spacer, and a plurality of electrically conductive interconnects;

FIG. 13 is a perspective view of a wafer stack comprising a plurality of ceramic wafers, wherein a spacer and a plurality of electrically conductive interconnects is disposed in between each pair of adjacent wafers;

FIG. 14 is a schematic illustration of a straight-on side view of a wafer assembly to be implemented within an electrochemical stack of a stack assembly;

FIG. 15 is a schematic illustration of a cross-sectional straight-on side view of a stack assembly comprising an electrochemical stack and a terminal plumbing assembly;

FIG. 16 is a schematic illustration of a cross-sectional straight-on side view of layers and components of two wafers of an electrochemical stack; and

FIG. 17 is a schematic illustration of a cross-sectional straight-on side view of layers, components, and reactions occurring within and surrounding a wafer of an electrochemical stack.

### DETAILED DESCRIPTION

The present disclosure extends to systems, methods, and devices for oxygen concentration and pressurization. The systems, methods, and devices described herein output purified oxygen gas in a cost efficient and energy efficient manner that is deployable on-demand and eliminates the need for oxygen gas cylinders and cryogenic containers.

Specifically described herein and systems, methods, and devices for a stack assembly including an electrochemical stack and a terminal plumbing assembly. The electrochemical stack described herein includes a plurality of ceramic wafers, a plurality of ceramic spacers, and electrically conductive interconnects. The terminal plumbing assembly described herein includes ceramic and metal components, and is configured to reduce mechanical strain caused by a differential in the coefficients of thermal expansion (CTEs) between metal components and ceramic components.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element or step not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

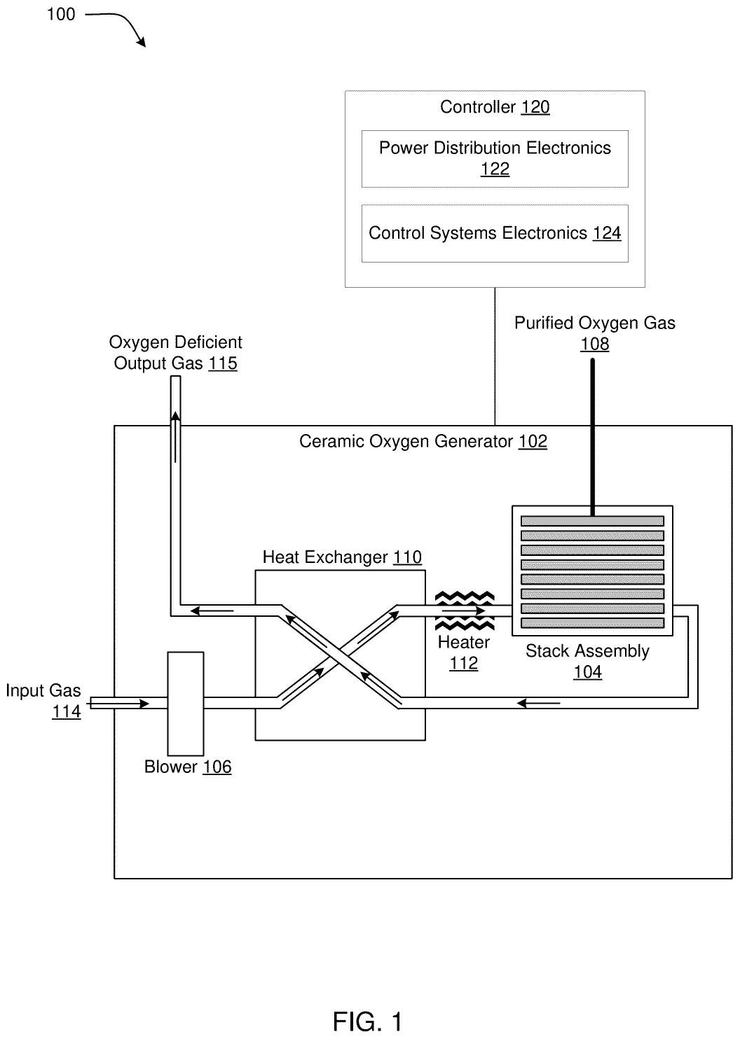

Referring now to the figures, FIG. 1 is a schematic illustration of a system 100 for ceramic oxygen purification. The system 100 includes two major portions, including a controller 120 that operates at ambient temperature, and a ceramic oxygen generator (COG) 102 that operates at elevated temperatures. The controller 120 includes at least power distribution electronics 122 and control systems electronics 124.

The COG 102 is fed with an input gas 114, which may specifically include ambient air. The input gas 114 may be pulled into the COG 102 with a blower 106. The air flow path may be open and unrestricted such that the performance specifications for the blower 106 may be minimal and similar to those of ventilation blowers utilized in residential settings (e.g., about 0.35-0.55 cubic meters per minute).

The input gas 114 is drawn into a heat exchanger 110 and then heated with a heater 112 prior to being processed through a stack assembly 104. The stack assembly 104 includes an electrochemical stack (see 202) comprising a plurality of ceramic wafers (see 206). The stack assembly 104 additionally includes a terminal plumbing assembly (see 208) that comprises metal components and ceramic components to compensate for a differential in CTEs between a metal oxygen port and the ceramic components of the electrochemical stack.

The stack assembly 104 extracts oxygen from the input gas 114, outputs purified oxygen gas 108 through a central pipe, and adds heat to the input gas 114 because the ion transport process produces waste heat. The stack assembly 104 comprises an impermeable, dense, monolithic ceramic structure. The stack assembly 104 comprises ceramic materials capable of transporting oxygen ions when supplied with an electrical potential. These ceramic materials within the stack assembly 104 do not conduct electricity but are capable of transporting oxygen if supplied with an electric potential. The ion transport membranes of the stack assembly 104 are made from ion-conducting ceramic oxides, which are insensitive to elevated temperature oxygen service. These ceramic oxide materials can be formed into dense structures, and when constructed into an operational device, may take the shape of a membrane that is gas impermeable. When the ion transport membrane is connected to a “strongback” structure, the ion transport membrane forms a hermetic seal with the input gas 114 on one side and oxygen deficient output gas 115 on the other side.

The operating temperature for the stack assembly 104 may be from about 500° C. to about 900° C. The heat exchanger 110 may comprise a dual-purpose heat exchanger that simultaneously preheats the input gas 114 while cooling oxygen deficient output gas 115. This arrangement reduces energy consumption and simplifies venting requirements by reducing the temperature of the oxygen deficient output gas 115. The heater 112 provides a significant amount of heating during transient startup and operates under reduced loads in steady-state operation.

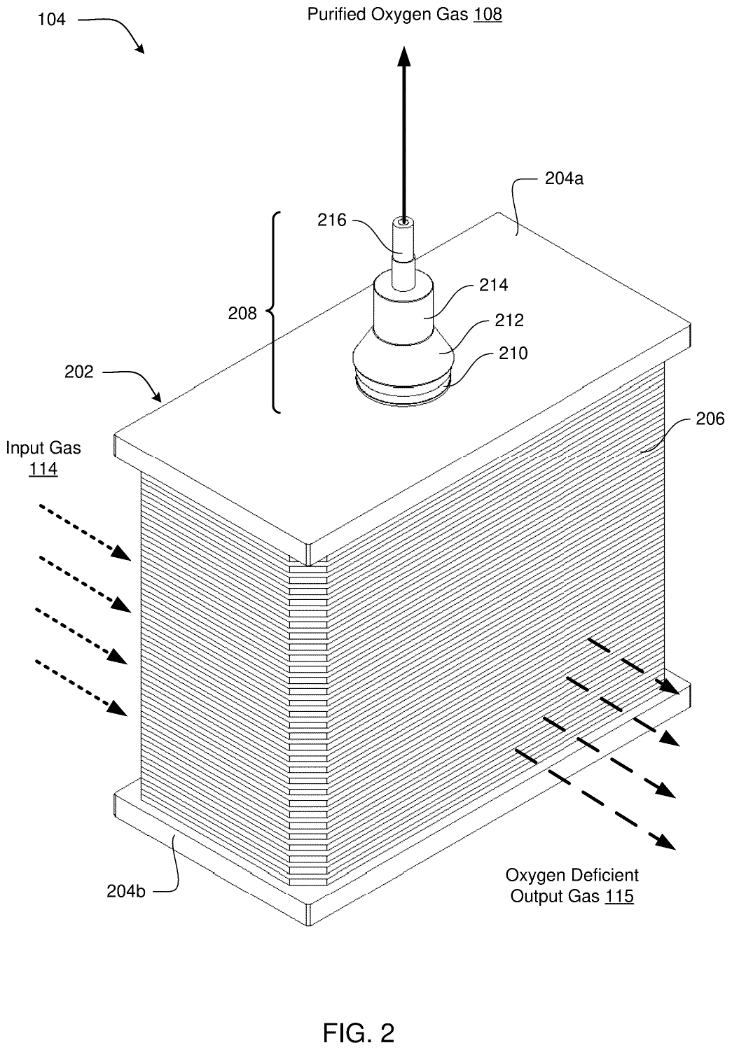

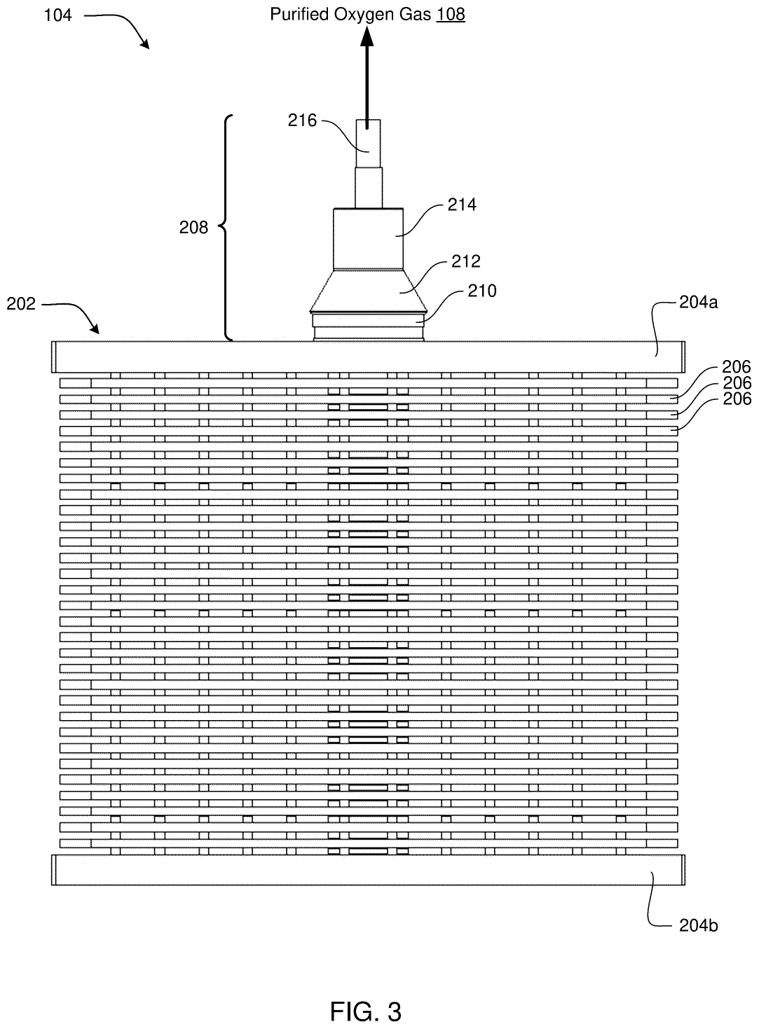

FIGS. 2 and 3 are views of the stack assembly 104 for ceramic oxygen generation. FIG. 2 is a perspective view of the stack assembly 104 and FIG. 3 is a straight-on side view of the stack assembly 104. The stack assembly 104 includes an electrochemical stack 202 and a terminal plumbing assembly (TPA) 208. The electrochemical stack 202 comprises a plurality of ceramic wafers 206 that receive an input gas 114 and output purified oxygen gas 108 and an oxygen deficient output gas 115. The TPA 208 reduces mechanical strain placed on the delicate ceramic components of the electrochemical stack 202, and in particular a first terminal plate 204a, due to a mismatch in coefficients of thermal expansion (CTEs) between the first terminal plate 204a, or ceramic wafers 206 in the case of an electrochemical stack without a first terminal plate 204a, and a metal output tube.

The electrochemical stack 202 comprises a plurality of wafers 206 sandwiched between a first terminal plate 204a that includes a hole therethrough substantially aligned with a hole through the TPA 208, and a second terminal plate 204b. The purified oxygen gas 108 is output via a tube stub 216 that feeds into an outlet tube (not shown), and the outlet tube may then feed the purified oxygen gas 108 to one or more of a storage vessel or an end-use.

The electrochemical stack 202 outputs purified oxygen gas 108 streams in excess of 85% purity at high volumes. The purity of the oxygen flow of the electrochemical stack 202 may be equivalent to or superior to the purity of the oxygen flow of cryogenic separation systems. The other constituents of air (e.g., nitrogen, argon, carbon dioxide, and excess oxygen) are unaffected by the ion transport membrane of the electrochemical stack 202.

The plurality of wafers 206 each comprises a hole disposed therethrough, and these holes may be aligned to form a central chimney that allows the purified oxygen gas 108 to be delivered through the tube stub 216. The wafers 206 accept gaseous molecules when the input gas 114 (may include air or some other oxygen-containing gas) is passed through the electrochemical stack 202. The wafers 206 separate oxygen ions from other components in the input gas 114, such as argon gas, nitrogen gas, carbon dioxide, and others. The purified oxygen gas 108 is harnessed and may be stored in a tank or immediately used. The other non-oxygen components of the input gas 114 (i.e., the oxygen deficient output gas 115) may also be harnessed or may be released into the environment. The electrochemical stack 202 generates high purity or ultra-purified oxygen gas using only a fraction of the energy that is required to deploy traditional oxygen purification methods such as cryogenic air separation and/or pressure swing adsorption and/or vacuum swing adsorption and/or water electrolysis.

The TPA 208 joins the electrochemical stack 202 to the tube stub 216, and specifically serves to mitigate mechanical stress caused by different thermal expansion properties for the electrochemical stack 202 and the tube stub 216. The electrochemical stack 202 comprises wafers 206 constructed of a ceramic material, and the tube stub 216 comprises a metal. The ceramic material(s) of the electrochemical stack 202 comprise a lower coefficient of thermal expansion (CTE) than the metal(s) of the tube stub 216. Thus, during heating, the metal tube stub 216 attempts to expand more than the ceramic electrochemical stack 202, and this creates compressive stress within the metal and tensile stress within the ceramic. Further, during cooling, the metal contracts more than the ceramic, and this causes tensile stress within the metal and compressive stress within the ceramic. Because ceramics are generally weak under tensile stress, this can lead to cracking and leaking at or near the ceramic-metal joint.

The TPA 208 is designed to mitigate stress at the ceramic-metal joint to prevent the formation of cracks and leaks within the stack assembly 104. The TPA 208 includes a ceramic adapter 210, adapter skirt 212, metal adapter 214, and the tube stub 216. The purified oxygen gas 108 passes through the TPA 208 and exits via the tube stub 216, where it may then feed into an outlet tube to be stored within a vessel or provided directly to an end-use.

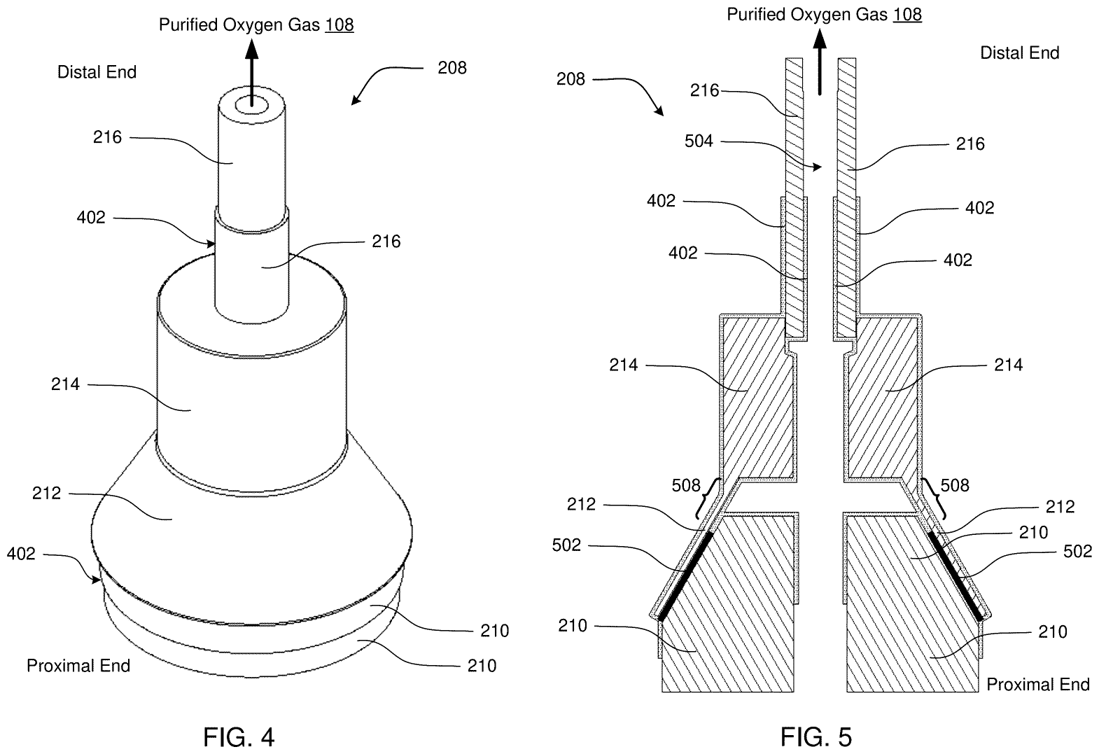

FIG. 4 is a perspective view of the TPA 208, which is a component of the stack assembly (see 104) for ceramic oxygen generation. The TPA 208 includes the ceramic adapter 210, adapter skirt 212, metal adapter 214, and tube stub 216. As shown in FIG. 4, the TPA 208 may include a secondary seal 402 attached to one or more of the internal or external surfaces of the TPA 208.

The ceramic adapter 210 is constructed of a ceramic material and is attached to the first terminal plate 204a of the electrochemical stack 202. The ceramic adapter 210 isolates the electrochemical stack 202 from the elevated mechanical stress endured at the metal-ceramic seal (see 502 at FIGS. 5-7) within the TPA 208. The ceramic adapter 210 may be constructed and sintered independently from the ceramic components of the electrochemical stack 202, such as the wafers 206 and terminal plates 204a-204b. At least a portion of the ceramic adapter 210 comprises a frustrum geometry that corresponds with a frustrum geometry of the adapter skirt 212.

The metal adapter 214 is attached to the tube stub 216 and provides weld stress isolation. The metal adapter 214 comprises a sidewall that defines a hollow cylindrical geometry. The sidewall may be relatively thick, and in some cases, a thickness of the sidewall is equal to or greater than a width of the hollow center of the hollow cylindrical geometry. The thickness of the metal adapter 214 aids in dictating the strain the TPA 208 endures in response to thermal expansion or contraction. The metal adapter 214 is constructed of a high-temperature oxidation resistant metal, and may specifically be constructed of a stainless steel material. In some cases, the metal adapter 214 is constructed from stainless steel 446, which is a ferritic stainless steel alloy with high chromium content (may include from about 20 wt. % to about 30 wt. % chromium), low carbon content, good heat resistance, good thermal conductivity, and high corrosion resistance.

The adapter skirt 212 is attached to the metal adapter 214. Unlike the thick sidewall of the metal adapter 214, the adapter skirt 212 is thin walled to reduce the amount of force or stress imparted by the adapter skirt 212 on to the ceramic adapter 210 during thermal expansion and contraction. The adapter skirt 212 comprises a hollow frustrum geometry, wherein a top circle of the hollow frustrum is attached to the metal adapter 214, and a bottom circle of the hollow frustrum is disposed around the ceramic adapter 210.

The adapter skirt 212 is disposed in between the ceramic adapter 210 and the metal adapter 214 to manage thermal expansion mismatch at the metal-ceramic seal (see 502 at FIGS. 5-7). The adapter skirt 212 is constructed of a metal and comprises the hollow frustrum geometry (may be referred to as truncated conical geometry). The hollow frustrum geometry creates a gradual stress transition rather than an abrupt interface, and this distributes mechanical stresses over a larger surface area along the length of the adapter skirt 212 to reduce peak stress concentrations that may cause failure. Additionally, the hollow frustrum geometry provides mechanical compliance and enables the adapter skirt 212 to flex and deform to accommodate differential thermal expansion. The angled sidewall of the adapter skirt 212 allows for some radial and axial movement without creating excessive stresses at the metal-ceramic seal interfaces.

The tube stub 216 is configured to interface with an output tube (not shown) that carries the purified oxygen gas 108 to a storage vessel, secondary purification system, and/or end-use. The tube stub 216 may be constructed of a heavy walled high-temperature oxidation resistant metal.

The secondary seal 402 may comprise a dense glass coating that serves several purposes for the TPA 208. The secondary seal 402 provides hermetic protection to create a gastight and watertight barrier that prevents gases, moisture, and contaminants from reaching the metal surfaces of the tube stub 216, metal adapter 214, and adapter skirt 212. This prevents corrosion and oxidation. Additionally, the secondary seal 402 provides electrical insulation, and this may be beneficial to ensure the metal components of the TPA 208 are electrically isolated during operation of the electrochemical stack 202. The secondary seal 402 additionally provides thermal stability because the dense glass can withstand significant temperature variations while maintaining protective properties.

FIG. 5 is a cross-sectional straight-on side view of the TPA 208, which is a component of the stack assembly 104 for ceramic oxygen generation. The cross-sectional side view in FIG. 5 illustrates the hollow interior 504 defined by the components of the TPA 208. The purified oxygen gas 108 output by the electrochemical stack 202 exits via the hollow interior 504 of the TPA 208 prior to flowing into an output tube (not shown).

The hollow interior 504 of the TPA 208 is defined by a thick sidewall of the tube stub 216, which comprises a hollow cylindrical geometry. The hollow interior 504 is further defined by a thick sidewall of the metal adapter 214, which also comprises a hollow cylindrical geometry. The hollow interior 504 is further defined by a thin sidewall of the adapter skirt 212, which comprises a hollow frustrum geometry. The hollow interior 504 is further defined by a thick ceramic sidewall of the ceramic adapter 210, which comprises a proximal portion having a hollow cylindrical geometry, and a distal portion having a thick-walled hollow frustrum geometry, as shown in FIG. 5.

As shown in FIG. 5, the adapter skirt 212 comprises a thin sidewall that defines a hollow frustrum geometry that is open on either end. The ceramic adapter 210 comprises a thick ceramic sidewall that defines a hollow cylindrical geometry at a proximal portion (i.e., the portion uncovered by the adapter skirt 212), and further defines a hollow frustrum geometry at a distal portion (i.e., the portion covered by the adapter skirt 212). As shown in FIG. 5, internal dimensions of the adapter skirt 212 correspond with external dimensions of the distal frustrum portion of the ceramic adapter 210. This enables the adapter skirt 212 to receive the ceramic adapter 210, and further enables the formation of the sealant 502 that binds an internal surface of the adapter skirt 212 to an external surface of the ceramic adapter 210.

The cross-sectional view in FIG. 5 enables visualization of the sealant 502 disposed in between the ceramic adapter 210 and the metal adapter skirt 212. The sealant 502 may comprise a glass sealant, a glass-ceramic sealant, a lithia-alumina-silica sealant, a fully devitrified sealant, or a metallic layer. The sealant 502 serves to couple the metal adapter skirt 212 to the ceramic adapter 210.

The sealant 502 is a gastight seal that prevents the loss of purified oxygen gas 108 passing through the TPA 208. The sealant 502 may specifically comprise a glass sealant or glass-ceramic sealant that shrinks considerably during processing. The hollow frustrum geometry of the adapter skirt 212, and the corresponding frustrum portion of the ceramic adapter 210, allows the adapter skirt 212 to displace downward during glass shrink to create a minimal gap located perpendicular to the wall of the adapter skirt 212.

The cross-sectional view in FIG. 5 further enables visualization of a strain relief zone 508 disposed in between the metal adapter 214 and the ceramic adapter 210. The strain relief zone 508 is a portion of the thin-walled adapter skirt 212 located in between the metal adapter 214 and the metal-ceramic sealant 502. The strain relief zone 508 may further be described as comprising the empty negative space defined by an extension of the thin-walled adapter skirt 212. The strain relief zone 508 reduces the impacts of CTE differential between the metal and ceramic components of the stack assembly 104.

As shown in FIG. 5, the TPA 208 may include the secondary seal 402 disposed on one or more of the interior surfaces or exterior surfaces of the TPA 208. As shown in FIG. 5, the secondary seal 402 is attached to the interior and exterior surfaces of a portion of the tube stub 216, an entirety of the metal adapter 214, an entirety of the adapter skirt 212, and a portion of the ceramic adapter 210.

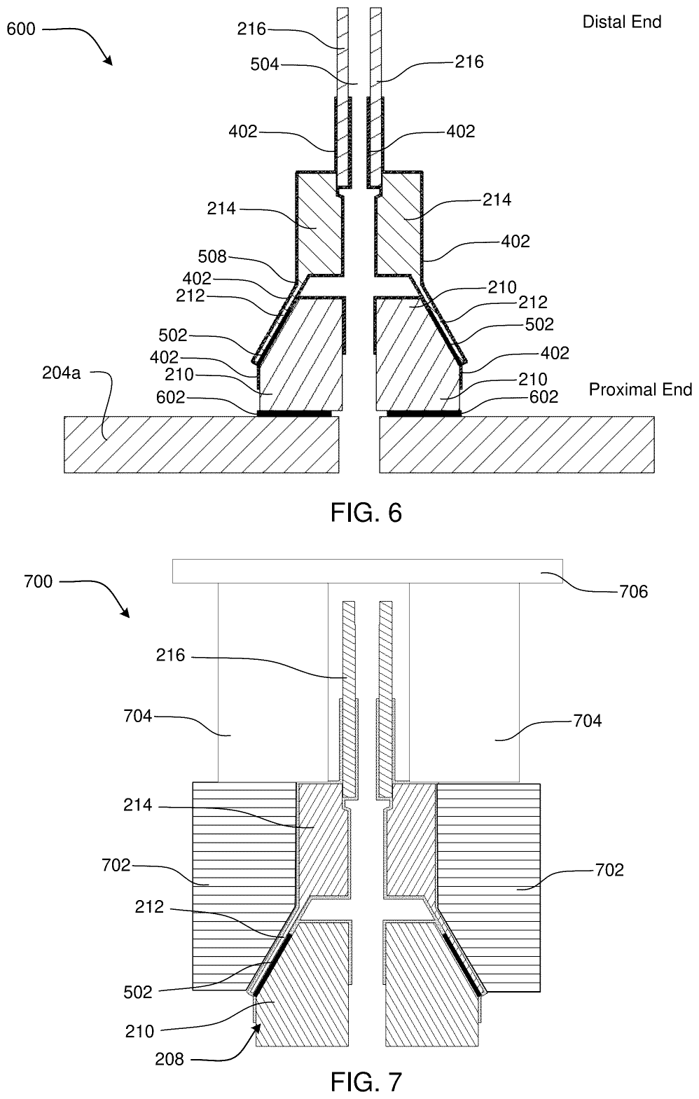

FIG. 6 is a cross-sectional straight-on side view of an assembly 600 comprising the TPA 208 and the first terminal plate 204a. The assembly 600 illustrates the ceramic-ceramic seal 602 disposed in between the first terminal plate 204a of the electrochemical stack 202 and the ceramic adapter 210 of the TPA 208.

The ceramic adapter 210 of the TPA 208 may be constructed separately from other components of the TPA 208, and may further be constructed separately from the first and second terminal plates 204a, 204b and the wafers 206 of the electrochemical stack 202. The ceramic-ceramic seal 602 between the first terminal plate 204a and the ceramic adapter 210 may be made before the remaining components of the electrochemical stack 202 (e.g., wafers 206 and second terminal plate 204b) are installed. The manufacturing process may include performing a leak test on the assembly 600 prior to combining the assembly 600 with other components of the stack assembly 104 (e.g., wafers 206 and second terminal plate 204b).

One or more metal components of the TPA 208 may be constructed as a single element and then later sealed to the ceramic adapter 210. In some implementations, the metal adapter 214 and the adapter skirt 212 are manufactured as a single indivisible element, and the tube stub 216 is then welded to the metal adapter 214. In another implementation, each of the tube stub 216, the metal adapter 214, and the adapter skirt 212 is manufactured as a single indivisible element without a separate joining process.

The secondary seal 402 may be applied to at least a portion of the metal components of the TPA 208 (i.e., the tube stub 216, metal adapter 214, and adapter skirt 212) prior to sealing the adapter skirt 212 to the ceramic adapter 210. The secondary seal 402 may additionally or alternatively be applied to at least a portion of all components of the TPA 208, including the ceramic adapter 210, after the adapter skirt 212 is sealed to the ceramic adapter 210.

FIG. 7 is a cross-sectional straight-on side view of a manufacturing assembly 700 for creating the metal-ceramic seal (see 502) between the adapter skirt 212 and the ceramic adapter 210. The manufacturing assembly 700 includes support blocks to be utilized during a ceramic firing process.

The manufacturing assembly 700 includes a metal support 702, a load spacer 704, and a dead load 706. The metal supports 702 are constructed to match an external geometry of the adapter skirt 212 and metal adapter 214. The load spacers 704 may comprise cuboid ceramic blocks that rest on the metal supports 702 and stand on either side of the tube stub 216. The dead load 706 rests on top of the load spacers 704 and provides a constant downward pressure that aids in creating a successful sealant 502 in between the ceramic adapter 210 and the metal adapter 212.

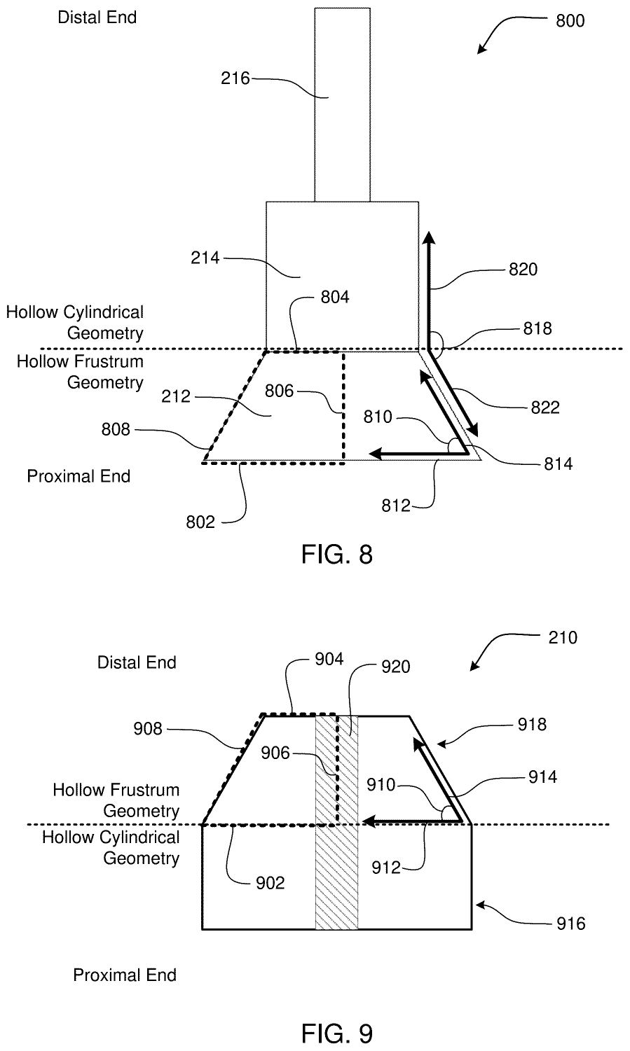

FIG. 8 is a straight-on side view of metal components 800 of a TPA (see 208), which includes the tube stub 216, metal adapter 214, and adapter skirt 212. The tube stub 216 and metal adapter 214 each comprise a sidewall defining a hollow cylindrical geometry. The adapter skirt 212 is attached to a proximal end of the metal adapter 214 and comprises a thin sidewall that defines a hollow frustrum geometry comprising an open end on the bottom and top. The hollow interior of the adapter skirt 212 is optimized to receive a corresponding frustrum portion of the ceramic adapter, as shown in the cross sectional view of FIGS. 5-7.

The frustrum geometry of the adapter skirt 212 defines a lower radius 802 (i.e., radius of the larger open base), an upper radius 804 (i.e., radius of smaller open top), a height 806 defined as a perpendicular distance between the circular faces of the larger base and the smaller top, and a slant height 808 defined as a distance along the slanted side between the two circular faces of the hollow frustrum.

The upper radius 804 of the adapter skirt 212 may be equal to the radius of the cylindrical metal adapter 214, within a manufacturing tolerance threshold of 10%. The lower radius 802 of the adapter skirt 212 is larger than the upper radius 804 of the adapter skirt 212. The upper radius 804 may be from about 20% to about 90% the length of the lower radius 802, and may specifically be from about 40% to about 65% the length of the lower radius 802.

The hollow frustrum geometry of the adapter skirt 212 defines an interior skirt angle 810. As shown in FIG. 8, the interior skirt angle 810 is defined by a first ray 812 running parallel to an interior bottom surface of the adapter skirt 212, and a second ray 814 running parallel to an interior surface of the slanted sidewall of the adapter skirt 212. The interior skirt angle 810 is from 10° to about 85° and may specifically be from about 30° to about 60°.

The hollow frustrum geometry of the adapter skirt 212 further defines an exterior skirt angle 818. As shown in FIG. 8, the exterior skirt angle 818 is defined by a first ray 820 running parallel to an external surface of the sidewall of the metal adapter 214, and a second ray 822 running parallel to an exterior surface of the slanted sidewall of the adapter skirt 212. The exterior skirt angle 818 is from about 95° to about 170°, and may specifically be from about 130° to about 160°.

FIG. 9 is a schematic illustration of a cross-sectional straight-on side view of the ceramic adapter 210. The ceramic adapter 210 comprises a proximal portion 916 and a distal portion 918 having different geometries. The proximal portion 916 comprises a thick ceramic sidewall defining a hollow cylindrical geometry, which defines a portion of a cylindrical hole 920 disposed through the ceramic adapter 210. The distal portion 918 comprises a thick ceramic sidewall defining another portion of the cylindrical hole 920 disposed through the ceramic adapter 210, and further defining an external frustrum geometry that corresponds with the hollow frustrum geometry of the adapter skirt 212.

The distal portion 918 comprises an external frustrum geometry that corresponds with the internal frustrum geometry of the adapter skirt 212. The frustrum geometry of the ceramic adapter 210 defines a lower radius 902 (i.e., radius of the larger base of the distal portion 918), an upper radius 904 (i.e., radius of smaller top of the distal portion 918), a height 906 defined as a perpendicular distance between the circular faces of the larger base and the smaller top, and a slant height 908 defined as a distance along the slanted side between the two circular faces of the frustrum. The dimensions of the frustrum geometry of the ceramic adapter 210 correspond with the dimensions of the frustrum geometry of the adapter skirt 212, such that the adapter skirt 212 receives the frustrum of the ceramic adapter 210, and the metal-ceramic seal (see 502) is formed in between the adapter skirt 212 and the ceramic adapter 210.

The external frustrum geometry of the ceramic adapter 210 defines an interior skirt angle 910. As shown in FIG. 9, the interior skirt angle 910 is defined by a first ray 912 running parallel to a bottom surface of the frustrum geometry of the distal portion 918 of the ceramic adapter 210, and a second ray 914 running parallel to a surface of the slanted sidewall of the frustrum geometry of the distal portion 918 of the ceramic adapter 210. The interior skirt angle 910 is from 10° to about 85° and may specifically be from about 30° to about 60°.

The interior skirt angle 910 of the ceramic adapter 210 may be equal to the interior skirt angle 810 of the adapter skirt 212, within a manufacturing tolerance threshold of about 10%. The interior skirt angle 910 of the ceramic adapter 210 may be equal to 180° minus the exterior skirt angle 818 of the adapter skirt 212, within a manufacturing tolerance threshold of about 10%.

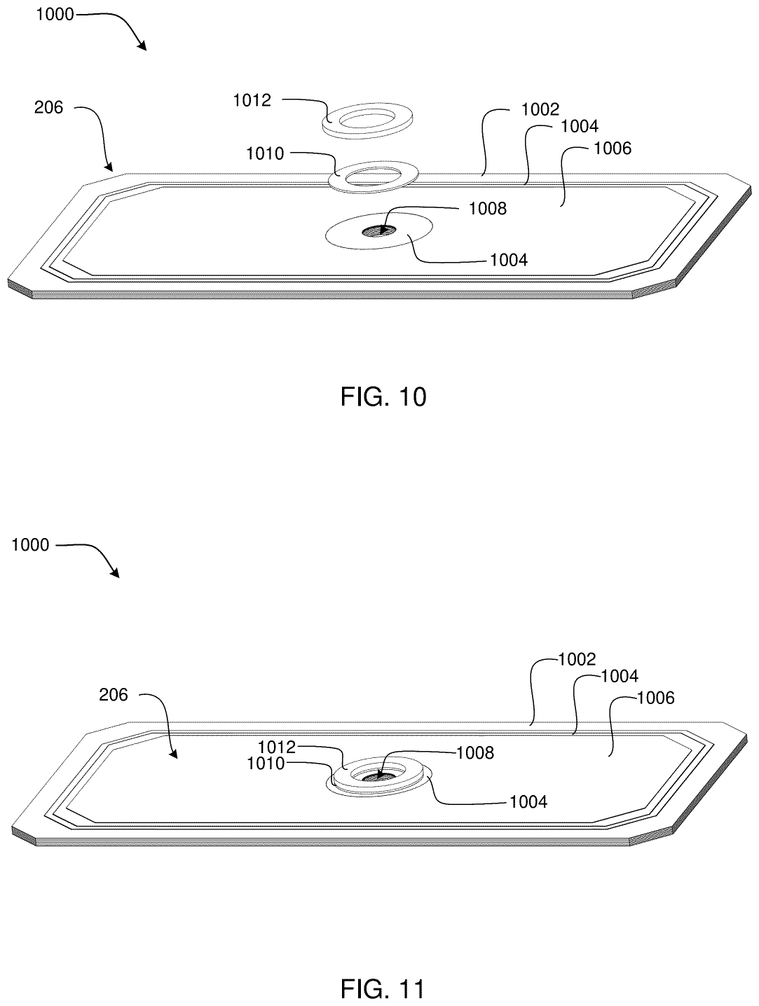

FIG. 10 is an exploded perspective view of a wafer-spacer assembly 1000, which is a component of the electrochemical stack (see 202) of the stack assembly (see 104). The wafer-spacer assembly 1000 may be repeated any number of times in the electrochemical stack 202 as deemed necessary based upon the desired use-case.

The wafer-spacer assembly 1000 includes a wafer 206 that comprises at least a structural support 1002, electrolyte 1004, and an external porous layer 1006. The wafer 206 additionally includes an oxygen delivery hole 1008 disposed through a central region of the wafer 206. The wafer-spacer assembly 1000 include the wafer 206 and additionally includes a sealant 1010 and a spacer 1012.

The spacer 1012 is constructed of a ceramic material and comprises a washer configuration. The spacer 1012 may specifically be constructed of a nonporous ceramic material that is sufficiently nonporous to prevent molecular diffusion across the spacer 1012. This may be referred to as “closed porosity,” wherein pores within the material are enclosed and isolated from the surface and other pores, such that the pores are “trapped” spaces that cannot be accessed by fluids or gases from the outside.

The spacer 1012 includes a sidewall defining a hollow cylindrical geometry, and a height of the hollow cylindrical geometry is optimized to ensure optimum spacing between wafers 206 within an electrochemical stack 202. A radius of the internal hole within the hollow cylindrical geometry of the spacer 1012 may be equal to a radius of the oxygen delivery hole 1008 disposed through the wafer, at least within a manufacturing tolerance threshold of 10%.

The sealant 1010 bonds a bottom side of the spacer 1012 to a planar surface of the electrolyte 1004 of the wafer 206. Thus, a portion of the spacer 1012 is disposed within the wafer 206 (i.e., sealed to the electrolyte 1004 and surrounded by the external porous layer 1006), and a portion of the spacer 1012 extends externally above the wafer 206 to form a gap between adjacent wafers 206. The exposed portion of the spacer 1012 defines the gap in between the adjacent wafers 206, and further defines a height of an electrically conductive interconnect disposed in between the wafers (see 1210, 1212).

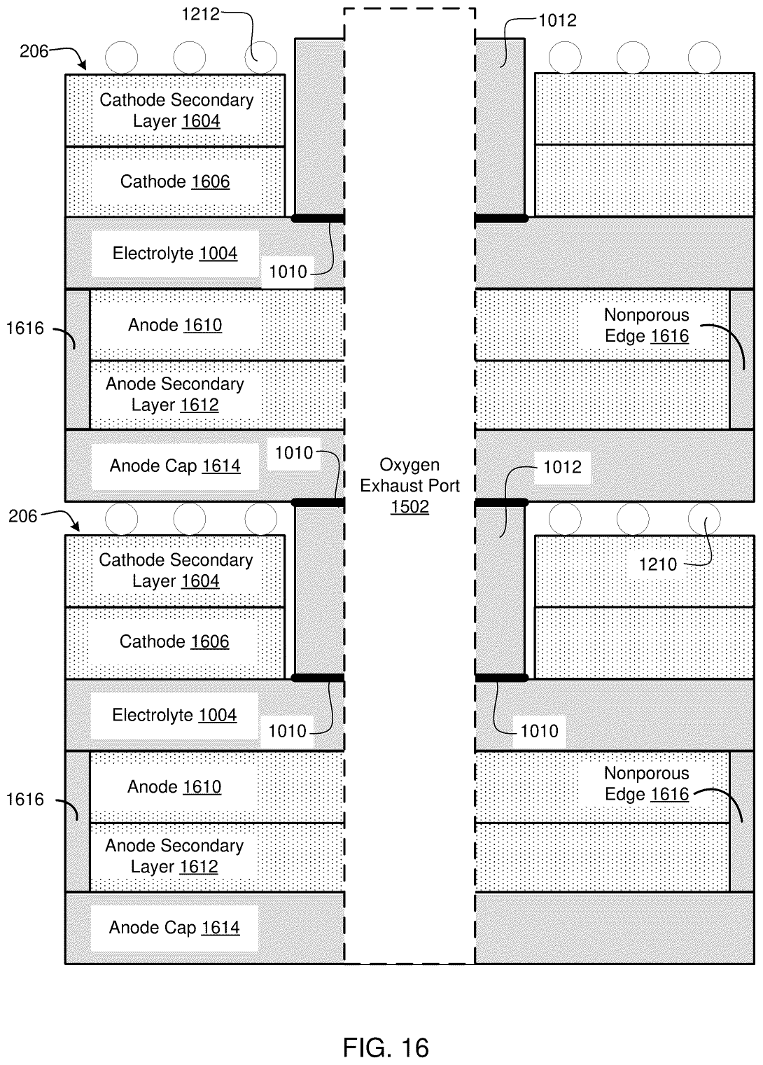

In a stack of two or more wafers 206, the sealant 1010 may further be applied to bond a top surface of the spacer 1012 to a bottom surface of the adjacent wafer 206 (see, e.g., FIG. 16 wherein the spacer 1012 is bonded to the electrolyte 1004 of a bottom wafer; and the spacer 1012 is further bonded to the anode cap 1614 of an adjacent wafer 206). Thus, a repeating wafer-spacer assembly may include, from bottom to top: (i) a first ceramic wafer; (ii) a first sealant; (iii) a ceramic spacer; (iv) a second sealant; and (v) a second ceramic wafer. Each of the first and second sealants is a gastight seal, and may remain gastight after undergoing two or more sintering cycles.

The sealant 1010 may comprise a glass-ceramic seal, which is a specialized sealing component that combines properties of both glass and ceramic materials to create a hermetic (i.e., gastight) seal. The glass-ceramic sealant 1010 begins as a class composition that undergoes controlled crystallization in response to being heated to form a glass-ceramic material. The glass-ceramic sealant 1010 forms a gastight seal in between the electrolyte 1004 and the spacer 1012, and further provides high chemical resistance, low thermal expansion, good electrical insulation, high temperature resistance, and high mechanical strength.

The sealant 1010 described herein exhibits unexpectedly good results and overcomes issues known in the prior art, wherein sealants commonly fail and develop leaks after undergoing multiple sintering cycles. The sealant 1010 described herein, and specifically the combination of (i) a first glass-ceramic seal disposed in between a ceramic spacer and an electrolyte of a ceramic wafer; and (ii) a second glass-ceramic seal disposed in between the ceramic spacer and the anode cap of an adjacent ceramic wafer, is capable of maintaining a gastight seal after undergoing two or more sintering cycles.

The spacer 1012 may be constructed independently of other ceramic components of the stack assembly 104, including, for example, the wafers 206, the terminal plates 204a, 204b, and the ceramic adapter 210. The spacer 1012 may be sealed (see 1010) to the electrolyte 1004 of the wafer 206 after the wafer 206 has undergone quality control analysis to text for effectiveness and gas leaks. This represents a significant improvement over traditional manufacturing methods, wherein an entire electrochemical stack 202 is co-sintered as a single unit. The separate manufacturing as described herein enables the production of “sub-stacks” comprising a fractional number of wafers 206 and spacers 1012. The sub-stacks may include two, three, four, five, six, and so forth wafers that are sintered together with spacers in between. These sub-stacks may undergo quality control analysis, including leak testing, prior to combining two or more sub-stacks to create a “full stack” that satisfies purified oxygen gas 108 flow rate specifications. This significantly reduces manufacturing waste by reducing the likelihood that an entire stack may be discarded based on the presence of gas leaks. Additionally, the glass-ceramic sealant 1010 and the ceramic materials of the wafers 206 and spacers 1012 can undergo multiple high-temperature firing cycles, so identified leaks within a wafer-spacer assembly, sub-stack, or full stack may be repaired with additional firing.

FIG. 11 is a perspective view of the wafer-spacer assembly 1000. As shown in FIG. 11, the sealant 1010 and spacer 1012 are disposed against a surface of the wafer 206 while ensuring the oxygen delivery hole 1008 remains open. The sealant 1010 serves to seal the ceramic spacer 1012 to the ceramic wafer 206, and the spacer 1012 serves as a spacer in between the wafer 206 and an additional wafer (not shown) that may be disposed above the wafer 206 within an electrochemical stack 202.

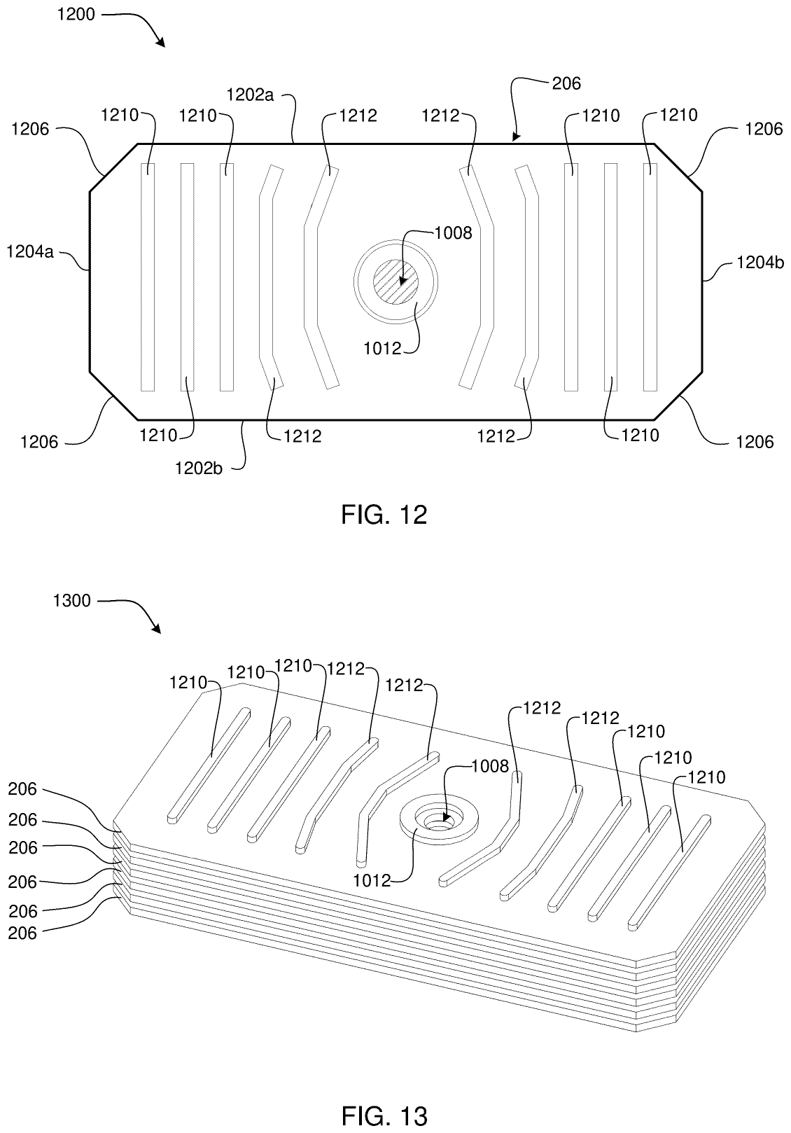

FIG. 12 is a schematic illustration of an aerial top-down view of a wafer assembly 1200. The wafer assembly 1200 includes a wafer 206, spacer 1012, and a plurality of interconnects 1210, 1212 attached to a surface of the wafer 206.

The wafer 206 may include a quadrilateral planar geometry as shown in FIG. 12. The quadrilateral geometry may include two longer sides 1202a, 1202b and two shorter sides 1204a, 1204b. The quadrilateral geometry may further include one or more chamfered corners 1206 as shown in FIG. 12. The wafer 206 may include the quadrilateral planar geometry with one or more rounded corners.

The wafer assembly 1200 includes interconnects 1210, 1212 formed on the top surface of the wafer 206. The interconnects 1210, 1212 serve to provide electrochemical communication between adjacent wafers 206 within an electrochemical stack (see 202). The interconnects 1210, 1212 may be referred to as “ribs” as they run across a width of an upper face of the wafer 206, as shown in the FIG. 12. The interconnects 1210, 1212 are constructed of a material comprising high electrical conductivity and low electrical resistance. When a voltage is applied to the electrochemical stack (see 202), the interconnects 1210, 1212 serve as a current carrier between adjacent wafers 206.

The interconnects 1210, 1212 are electrically conductive and may comprise a combination of a partially or wholly sintered ceramic powder, and an electrically conductive metal. The interconnects 1210, 1212 may comprise only a partially or wholly sintered ceramic powder. The interconnects 1210, 1212 may include a composition that comprises two or more of (a) an electrically conductive metal; (b) an non electrically conductive ceramic; or (c) an electrically conductive ceramic.

The interconnects 1210, 1212 may comprise from about 5 vol. % to about 80 vol. % the electrically conductive metal, and may specifically comprise from about 30 vol. % to about 70 vol. % the electrically conductive metal. The interconnects 1210, 1212 may comprise from about 10 vol. % to about 75 vol. % the electrically conductive metal; from about 15 vol. % to about 75 vol. % the electrically conductive metal; from about 20 vol. % to about 75 vol. % the electrically conductive metal; from about 25 vol. % to about 75 vol. % the electrically conductive metal; from about 10 vol. % to about 75 vol. % the electrically conductive metal; from about 10 vol. % to about 70 vol. % the electrically conductive metal; from about 10 vol. % to about 65 vol. % the electrically conductive metal; from about 15 vol. % to about 60 vol. % the electrically conductive metal; from about 15 vol. % to about 55 vol. % the electrically conductive metal; from about 15 vol. % to about 50 vol. % the electrically conductive metal; from about 15 vol. % to about 45 vol. % the electrically conductive metal; from about 15 vol. % to about 40 vol. % the electrically conductive metal. The electrically conductive metal may specifically include one or more of silver, gold, platinum palladium, nickel, ruthenium, or rhodium.

The interconnects 1210, 1212 may further comprise from about 20 vol. % to about 100 vol. % ceramic powder that is partially or wholly sintered, and may specifically comprise from about 30 vol. % to about 70 vol. % the partially or wholly sintered ceramic powder. The interconnects may comprise from about 25 vol. % to about 100 vol. % the partially or wholly sintered ceramic powder; from about 30 vol. % to about 100 vol. % the partially or wholly sintered ceramic powder; from about 35 vol. % to about 100 vol. % the partially or wholly sintered ceramic powder; from about 40 vol. % to about 100 vol. % the partially or wholly sintered ceramic powder; from about 45 vol. % to about 100 vol. % the partially or wholly sintered ceramic powder; from about 50 vol. % to about 100 vol. % the partially or wholly sintered ceramic powder; from about 55 vol. % to about 100 vol. % the partially or wholly sintered ceramic powder; from about 60 vol. % to about 100 vol. % the partially or wholly sintered ceramic powder; from about 65 vol. % to about 100 vol. % the partially or wholly sintered ceramic powder; from about 70 vol. % to about 100 vol. % the partially or wholly sintered ceramic powder; from about 75 vol. % to about 100 vol. % the partially or wholly sintered ceramic powder; from about 80 vol. % to about 100 vol. % the partially or wholly sintered ceramic powder; from about 85 vol. % to about 100 vol. % the partially or wholly sintered ceramic powder; or from about 90 vol. % to about 100 vol. % the partially or wholly sintered ceramic powder. In some cases, the interconnects 1210, 1212 do not include the electrically conductive metal, and are instead made only from a partially or wholly sintered ceramic.

The interconnects 1210, 1212 comprise a through-porosity such that oxygen-containing gases can pass through and/or diffuse into the interconnects 1210, 1212. Specifically, at least one or more of oxygen gas, carbon dioxide gas, carbon monoxide gas, water vapor can pass through and/or diffuse into the interconnects 1210, 1212. The interconnects 1210, 1212 may comprise a porosity from about 5% to about 80%. The interconnects 1210, 1212 may specifically from about 10% to about 80%; or from about 15% to about 80%; or from about 20% to about 80%; or from about 25% to about 80%; or from about 30% to about 80%; or from about 5% to about 75%; or from about 5% to about 70%; or from about 5% to about 65%; or from about 5% to about 60%; or from about 5% to about 55%; or from about 10% to about 75%; or from about 15% to about 70%; or from about 20% to about 65%; or from about 25% to about 60%. The interconnects 1210, 1212 may comprise an open porosity of at least 5%. The interconnects 1210, 1212 may further comprise a resistance less than or equal to five milliohms.

The interconnects 1210, 1210 comprise a coefficient of thermal expansion (CTE) that is similar to the CTE of the surrounding wafer 206 layers the interconnects 1210, 1212 are bonded to. Specifically, the interconnects 1210, 1212 and bonded wafer 206 layers may comprise CTEs that comprise a differential up to 20%, or up to 15%, or up to 10%, or up to 5%. The ceramic phase of the interconnects 1210, 1212 may include a CTE from about 9×10⁻⁶ per degree Centigrade to about 15×10⁻⁶ per degree Centigrade. The ceramic phase of the interconnects 1210, 1212 may specifically include a CTE from about 11×10⁻⁶ per degree Centigrade to about 14×10⁻⁶ per degree Centigrade.

The interconnects 1210, 1212 comprise high mechanical strength and attachability. When the electrochemical stack (see 202) is operating, a high flow rate of input gas (see 114) is passing in between adjacent wafers 206, so the interconnects 1210, 1212 must have sufficient mechanical strength to ensure integrity is not harmed during operation. The interconnects 1210, 1212 have high dimensional stability to ensure the interconnects 1210, 1212 maintain physical contact between adjacent wafers 206 to enable electrical contact between wafers 206.

The interconnects 1210, 1212 may comprise a portion of straight line interconnects 1210 and bent line interconnects 1212 as shown in FIG. 12. The bent line interconnects 1212 may comprise one or more angle vertexes to enable the bent line interconnect 1212 to wrap around the spacer 1012 and oxygen delivery hole 1008. The bent line interconnects 1212 may specifically include two angle vertexes as shown in FIG. 12, such that the bent line interconnects 1212 comprise a middle parallel portion running parallel to an edge of the wafer 206, and further comprise two or more non-parallel portions that do not run parallel to an edge of the wafer 206.

FIG. 13 is a perspective view of a wafer stack 1300 comprising six wafers 206. One or more wafer stacks 1300 may be included in the electrochemical stack (see 202) of the stack assembly (see 104). The exemplary wafer stack 1300 illustrated in FIG. 13 includes six wafer-spacer assemblies (see 1000), although only the topmost wafer-spacer assembly is visible in the view of FIG. 13.

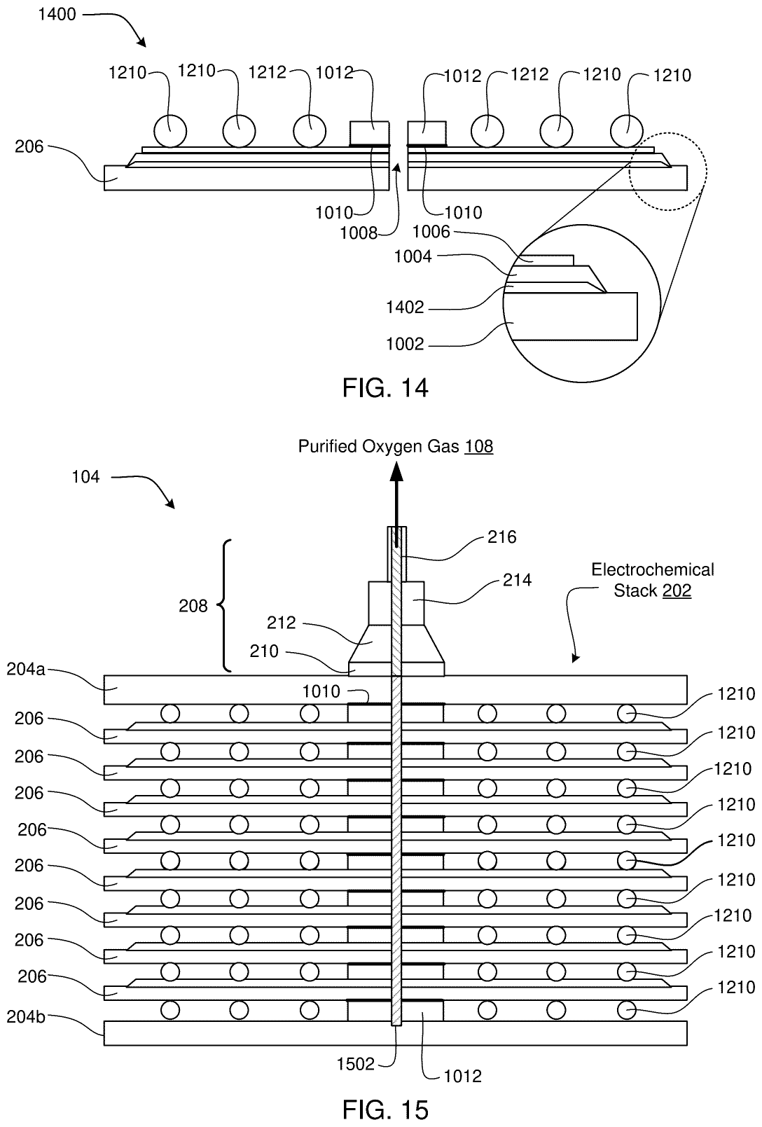

FIG. 14 is a schematic illustration of a straight-on cross-sectional side view of a wafer assembly 1400. The wafer assembly 1400 includes the components of the wafer-spacer assembly (see 900), including the wafer 206, spacer 1012, and sealant 1010 attaching the spacer 1012 to the wafer 206. The wafer assembly 1400 additionally includes a plurality of interconnects 1210, 1212 attached to an upper surface of the wafer 206.

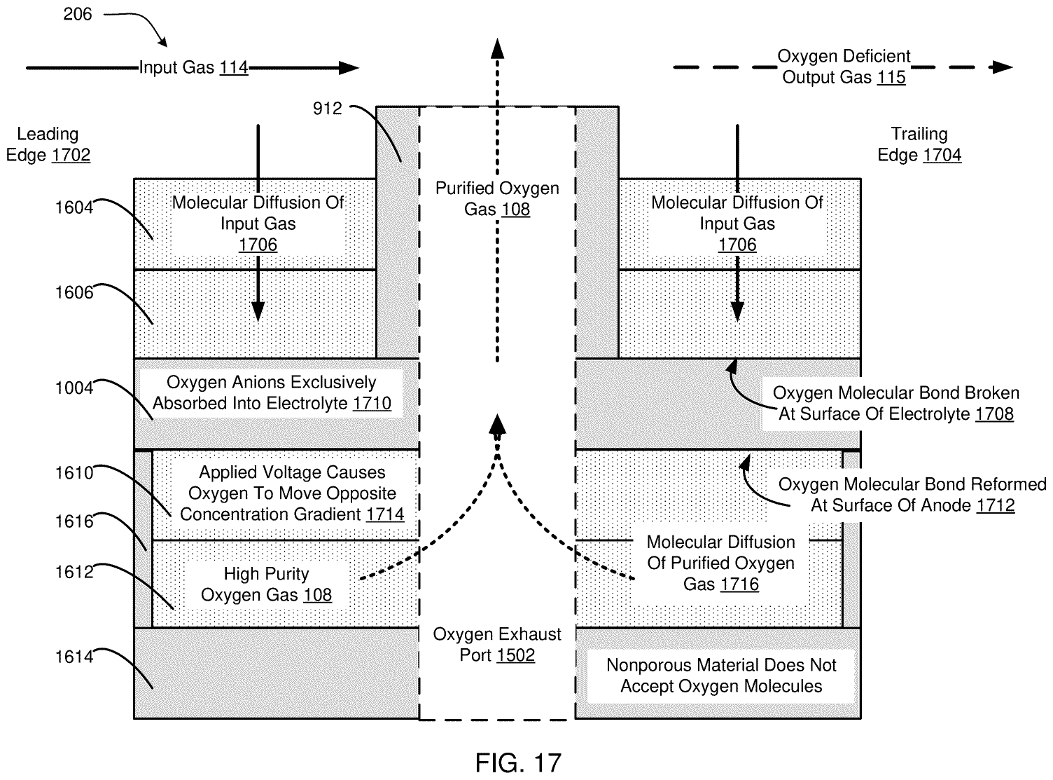

FIG. 14 additionally provides a close-up view of a cross-section of the wafer 206, which illustrates the structural support, an internal porous layer 1402, the electrolyte 1004, and the external porous layer 1006. In a first implementation, the internal porous layer 1402 is an anode and the external porous layer 1006 is a cathode. The first implementation is illustrated in FIGS. 16-17, and may be utilized when input gas (see 114) is passed in between the wafers 206, and the purified oxygen gas 108 exits via the tube stub 216, as shown at least in FIG. 2. In a second implementation, the internal porous layer 1402 is a cathode, and the external porous layer 1006 is an anode. The second implementation may be utilized when an input oxygen gas is fed into a central inlet pipeline and then diffused into the ceramic wafers 206.

The structural support 1002 is a strongback structural support that comprises a dense and solid material with no porosity, within a manufacturing tolerance threshold of up to 2% porosity. The internal and external porous layers 1402, 1006 comprise a porous material. During operation, the internal porous layer 1402 comprises purified oxygen gas 108 disposed between pores, and the external porous layer 1006 comprises oxygen-deficient output gas 115 disposed between pores. The electrolyte 1004 comprises a dense and solid material with no porosity, within a manufacturing tolerance threshold of up to 8% porosity. The electrolyte 1004 specifically includes a closed porosity such that the electrolyte is sufficiently nonporous to prevent molecular diffusion across the electrolyte 1004.

FIG. 15 is a schematic illustration of a cross-sectional straight-on side view of a stack assembly 104 comprising an electrochemical stack 202 and a TPA 208. The exemplary electrochemical stack 202 illustrated in FIG. 15 includes eight wafers 206 and nine spacers 1012. The spacers 1012 are disposed in between adjacent wafers 206, in between a top wafer 206 and the first terminal plate 204a, and in between a bottom wafer 206 and the second terminal plate 204b. Likewise, the interconnects are disposed in between adjacent wafers 206, in between a top wafer 206 and the first terminal plate 204a, and in between a bottom wafer 206 and the second terminal plate 204b.

The cross-sectional view in FIG. 15 depicts an oxygen exhaust port 1502 running a length of the electrochemical stack 202. The oxygen exhaust port 1502 connects with a similar hollow interior of the TPA 208 and ultimately ports the purified oxygen gas 108 to an output tube (not shown). The oxygen exhaust port 1502 is formed by the oxygen delivery hole 1008 formed within each of the plurality of wafers 206, and is further formed by the central hole formed in each of the plurality of spacers 1012.

FIG. 16 is a schematic illustration of a cross-sectional straight-on side view of two adjacent wafers 206 of an electrochemical stack (see 202) of a stack assembly (see 104). The wafers 206 serve as a ceramic ion transport membrane that extracts oxygen from an input gas 114 and then transports the oxygen across an impermeable, dense, monolithic ceramic structure.

Each wafer 206 includes a cathode, electrolyte 1004, and anode. The wafers 206 specifically include a cathode secondary layer 1604, cathode 1606, electrolyte 1004, anode 1610, anode secondary layer 1612, and anode cap 1614. The wafers 206 includes a nonporous edge 1616 that extends from the electrolyte 1004 to the anode cap 1614 to seal the porous anode 1610 and porous anode secondary layer 1612. The wafers 206 include the spacer 1012, which is sealed to the electrolyte 1004 and extends upward to seal the porous cathode 1606 and porous cathode secondary layer 1604. As shown in FIG. 16, the spacer 1012 extends above the surface of the cathode secondary layer 1604 and is sealed to the anode cap 1614 of an adjacent wafer 206.

The spacer 1012 provides a gap between two wafers 206 in the electrochemical stack 202. The gap enables the input gas 114 to enter at the leading edge of a wafer 206 and further enables the oxygen deficient output gas 115 to exit at the trailing edge of the wafer 206. The spacer 1012 surrounds an oxygen exhaust port 1502 that provides an outlet for purified oxygen gas 108 to exit the stack assembly (see 104).

The spacer 1012 may be co-sintered with the other layers of the wafer 206, including the cathode secondary layer 1604, cathode 1606, electrolyte 1004, anode 1610, anode secondary layer 1612, anode cap 1614, and nonporous edge 1616. In an alternative implementation, the spacer 1012 is manufactured separately from the other layers of the wafer 206, and the spacer 1012 is later sealed to the electrolyte 1004 and the anode cap 1614 of an adjacent wafer 206.

There are numerous benefits to the spacer 1012 being co-sintered with the remaining layers of the wafer 206. The spacer 1012 provides a gastight seal with the anode cap 1614 of an adjacent wafer 206 located above the spacer 1012, and the spacer 1012 further provides a gastight seal with the electrolyte 1004 of the same wafer 206. When the spacer 1012 is co-sintered with the other layers of the wafer 206, the gastight seal between the spacer 1012 and the electrolyte 1004 is structurally more rigid and provides an improved nonporous seal. There are numerous challenges associated with co-sintering the spacer 1012 with the other layers of the wafer 206. One such challenge is the sintering process may cause the spacer 1012 to curl and separate from the remaining layers due to differences in thickness, shape, and materials.

The cathode secondary layer 1604 is a porous material and is configured to receive the input gas 114. The input gas 114 is passed over the electrochemical stack 202 and over each wafer 206 within the electrochemical stack 202. The input gas 114 may be blown into the electrochemical stack 202. Molecular diffusion causes the input gas 114 to enter the cathode secondary layer 1604. The cathode 1606 is a porous material and is configured to receive the input gas 114 after the input gas 114 has passed through the cathode secondary layer 1604. Molecular diffusion causes the input gas 114 to enter the cathode 1606. The cathode 1606 makes direct contact with the electrolyte 1004.

The electrolyte 1004 is a specialized ceramic material that receives oxygen ions. The electrolyte 1004 is nonporous when compared with the cathode secondary layer 1604, cathode 1606, anode 1610, or anode secondary layer 1612. The electrolyte 1004 may be referred to as “nonporous,” but it should be appreciated the electrolyte 1004 may still have some unavoidable porosity due to its inherent ceramic properties. The electrolyte 1004 may specifically be described as having no through-porosity such that the electrolyte 1004 does not permit molecular diffusion across the electrolyte 1004 layer but will permit diffusion of oxygen ions across the electrolyte 1004 layer. There are oxygen atom deficiencies throughout the crystal structure of the electrolyte 1004. The electrolyte 1004 will not permit diffusion of ions other than oxygen ions (O²⁻). The input gas 114 located within the cathode 1606 may include oxygen molecules (O₂). A voltage is applied to the electrochemical stack 202 that enables a reduction reaction to occur to the oxygen molecules (O₂) at the surface of the electrolyte 1004. The reduction reaction follows Equation 1, below.

$${O}_{2} + 4 {e}^{-} \to 2 {O}^{2 -} \qquad Equation 1$$

The reduction of the oxygen molecules (see Equation 1) occurs at the surface of the electrolyte 1004, and it may also occur in the cathode 1606 in close proximity to the electrolyte 1004. The reduction of one oxygen molecule results in two oxygen ions. The two oxygen ions are accepted by the electrolyte 1004 to fill oxygen deficiencies within the crystal lattice structure of the electrolyte 1004 ceramic material. Oxygen ions travel within the crystal lattice structure of the electrolyte 1004, and possibly along grain boundaries of electrolyte 1004, and are eventually oxidized at the surface of the anode 1610 according to Equation 2, below.

$$2 {O}^{2 -} \to {O}_{2} + 4 {e}^{-} \qquad Equation 2$$

The anode 1610 is a porous material that accepts the oxygen molecules (O₂). During operation, a voltage, or EMF is applied to the electrochemical stack 202. Because of the EMF, the oxygen molecules created according to Equation 2 near the anode-side of the electrolyte 1004 may be consumed by the anode 1610 even when the oxygen molecules are travelling from the electrolyte 1004 to the anode 1610 against a concentration gradient. Because the electrolyte 1004 lacks through-porosity and will only accept oxygen ions, the anode 1610 and anode secondary layer 1612 may only consume pure oxygen. The electrolyte 1004 is such that there are no non-oxygen molecules or ions traveling through the electrolyte 1004 crystal lattice structure that may eventually reach the surface of the anode 1610. The anode secondary layer 1612 is a porous material that holds the purified oxygen gas 108 that is received by the anode 1610.

The anode cap 1614 is a nonporous material that prevents the purified oxygen gas 108 from traveling beyond the anode secondary layer 1612. There is a hole running through each of the layers of the wafer 206 such that the purified oxygen gas 108 may only travel through the oxygen exhaust port 1502 and be harvested by the system.

The spacer 1012 extends to the electrolyte 1004 to prevent contamination of the purified oxygen gas 108 that is traveling in the oxygen exhaust port 1502. The spacer 1012 is nonporous and does not permit any molecules or ions to pass through. The cathode secondary layer 1604 and the cathode 1606 each consume input gas 114 that includes oxygen along with other contaminants such as nitrogen, argon, and other particles. The nonporous spacer 1012 prevents the other contaminants from exiting the cathode secondary layer 1604 and/or the cathode 1606 and then ultimately entering the oxygen exhaust port 1502. The oxygen exhaust port 1502 only includes purified oxygen gas 108.

The anode cap 1614 is nonporous and provides a barrier similar to that provided by the spacer 1012. The anode cap 1614 prevents contaminants, such as nitrogen, argon, or other particles, from entering the oxygen exhaust port 1502. Further, the anode cap 1614 prevents the purified oxygen gas 108 that is located within the anode 1610 and/or the anode secondary layer 1612 from exiting the system and reentering the atmosphere. The purified oxygen gas 108 is located within the anode 1610 and the anode secondary layer 1612. The interior edges (i.e., the edge along the oxygen exhaust port 1502) of the anode 1610 and/or the anode secondary layer 1612 are open such that the purified oxygen gas 108 may exit and enter the oxygen exhaust port 1502. The purified oxygen gas 108 exits the system by way of the oxygen exhaust port 1502 where it may eventually be used on-site or harvested in a tank or other vessel.

Each of the anode 1610 and the anode secondary layer 1612 includes a nonporous edge 1616. The nonporous edge 1616 surrounds the perimeter of the anode 1610 and the anode secondary layer 1612. The nonporous edge 1616 prevents the purified oxygen gas 108 from exiting either of the anode 1610 and/or the anode secondary layer 1612 and reentering the atmosphere. The nonporous edge 1616, along with the electrolyte 1004 and the anode cap 1614, forces the purified oxygen gas 108 to exit the system by way of the oxygen exhaust port 1502.

FIG. 17 is a schematic diagram of a cross-sectional view of the wafer 206 further depicting the pathways of the input gas 114, oxygen deficient output gas 115, oxygen gas, oxygen ions, and oxygen molecules. The wafer 206 includes a leading edge 1702 and a trailing edge 1704. The input gas 114 passes over the wafer 206 starting with the leading edge 1702 and ending with the trailing edge 1704. The input gas 114 may pass over the wafer 206 beginning with the leading edge 1702. Input gas 114 enters the wafer 206 at the cathode secondary layer 1604. Molecular diffusion causes the input gas 114 to pass into the porous cathode secondary layer 1604 at 1706 until it reaches electrolyte 1004. Molecular diffusion causes the molecules of the input gas 114 to travel through the cathode secondary layer 1604 and the cathode 1606. The spacer 1012 prevents the molecules of the input gas 114 from entering the oxygen exhaust port 1502.

The oxygen molecules are reduced (see Equation 1) near the surface and at the surface of the electrolyte 1004 where the oxygen molecular bond is broken at 1708. The crystal structure of the electrolyte 1004 has oxygen deficiencies and causes the oxygen ions to travel through the electrolyte 1004. The electrolyte 1004 exclusively accepts oxygen ions at 1710. At the opposite end of the electrolyte 1004 at the surface of the anode 1610, the oxygen ions are oxidized (see Equation 2), and the oxygen molecular bond is reformed at 1712. A voltage or EMF is applied to the electrochemical stack 202 and this EMF causes the oxygen molecules to form near the surface of the anode 1610 as shown at 1712, even if there exists a high concentration of oxygen molecules in the anode 1610 and the anode secondary layer 1612. The anode 1610 and the anode secondary layer 1612 include only purified oxygen gas 108. The nonporous anode cap 1614 prevents the purified oxygen gas 108 from exiting the system and reentering the atmosphere at 1718. Molecular diffusion causes the purified oxygen gas 108 to leave the anode 1610 and/or the anode secondary layer 1612 to enter the oxygen exhaust port 1502 at 1716. The nonporous edge 1616 prevents the purified oxygen gas 108 from exiting the anode 1610 and/or the anode secondary layer 1612 and reentering the environment. The purified oxygen gas 108 may travel the length of the electrochemical stack 202 up the oxygen exhaust port 1502 where it may eventually be used on-site or harvested in a tank or other vessel.

As the system is operating, the purified oxygen gas 108 within the anode 1610 and/or the anode secondary layer 1612 builds pressure. Further, the input gas 114 within the cathode 404 and/or the cathode secondary layer 406 exists at one atmosphere of pressure when operating at sea level at ambient conditions. In an instance where the input gas 114 is air, the input gas 114 includes approximately 21% oxygen. In this instance, where purified oxygen gas 108 exists at some pressure within the anode and gas comprising 21% oxygen exists within the cathode at one atmosphere of pressure, the concentration gradient would push oxygen gas to the cathode where there is less concentration of oxygen. However, the voltage applied to the system causes the oxygen to move opposite the concentration gradient to exit the electrolyte 460 and enter the anode at 1714.

### Examples

The following examples pertain to further embodiments.

Example 1 is an assembly for outputting purified oxygen gas. The stack assembly includes an electrochemical stack comprising: a plurality of wafers, wherein the plurality of wafers comprises a first ceramic wafer and a second ceramic wafer; a ceramic spacer disposed in between the first ceramic wafer and the second ceramic wafer; and an interconnect disposed in between the first ceramic wafer and the second ceramic wafer that facilitates electrical communication between the first ceramic wafer and the second ceramic wafer. The stack assembly includes a metal tube for porting the purified oxygen gas output by the electrochemical stack. The stack assembly includes a terminal plumbing assembly that couples the electrochemical stack to the metal tube.

Example 2 is an assembly as in Example 1, wherein the terminal plumbing assembly includes a ceramic adapter, wherein at least a portion of the ceramic adapter comprises a frustrum geometry. The terminal plumbing assembly further includes a metal adapter comprising a sidewall defining a hollow cylindrical geometry. The terminal plumbing assembly further includes an adapter skirt attached to the metal adapter, wherein the adapter skirt extends outwardly to the sidewall of the metal adapter. The terminal plumbing assembly is such that the adapter skirt receives the ceramic adapter. The terminal plumbing assembly is such that a sealant is disposed in between an exterior surface of the ceramic adapter and an interior surface of the adapter skirt.

Example 3 is an assembly as in any combination of any of Examples 1-2, wherein the ceramic adapter is joined with a ceramic component of an electrochemical stack, and wherein the electrochemical stack comprises a plurality of ceramic wafers that output purified oxygen gas by transporting oxygen ions across an electrolyte membrane.

Example 4 is an assembly as in any combination of any of Examples 1-3, further comprising a metal tube attached to the metal adapter, wherein the metal tube comprises a hollow cylindrical geometry configured to receive a purified oxygen gas output by an electrochemical stack, and wherein the electrochemical stack comprises a plurality of ceramic wafers that output the purified oxygen gas by transporting oxygen ions across an electrolyte membrane.

Example 5 is an assembly as in any combination of any of Examples 1-4, wherein the adapter skirt comprises a hollow frustrum geometry such that the adapter skirt comprises: an upper circular base comprising an upper radius; and a lower circular base comprising a lower radius; wherein the lower radius is longer than the upper radius.

Example 6 is an assembly as in any combination of any of Examples 1-5, wherein the metal adapter comprises the hollow cylindrical geometry comprising an exterior radius; wherein a length of the upper radius of the adapter skirt is equal to a length of the exterior radius of the metal adapter within a manufacturing tolerance threshold of ten percent; and wherein the length of the upper radius of the adapter skirt is from about 30% to about 60% a length of the lower radius of the adapter skirt.

Example 7 is an assembly as in any combination of any of Examples 1-6, wherein the adapter skirt extends outward relative to the sidewall of the metal adapter to define an interior skirt angle; wherein the interior skirt angle is defined by a first ray running parallel to an interior bottom surface of the adapter skirt, and a second ray running parallel to an interior surface of a slanted sidewall of the adapter skirt; and wherein the interior skirt angle is from about 10° to about 85°.

Example 8 is an assembly as in any combination of any of Examples 1-7, wherein the interior skirt angle is from about 30° to about 60°.

Example 9 is an assembly as in any combination of any of Examples 1-8, further comprising a secondary seal disposed on at least a portion of interior surfaces and exterior surfaces of the metal adapter and the adapter skirt.

Example 10 is an assembly as in any combination of any of Examples 1-9, wherein the secondary seal comprises a glass seal.

Example 11 is an assembly as in any combination of any of Examples 1-10, further comprising a strain relief zone, wherein the strain relief zone comprises a portion of the adapter skirt that is not joined to the ceramic adapter with the sealant.

Example 12 is an assembly as in any combination of any of Examples 1-11, wherein the strain relief zone reduces effects of a differential in coefficients of thermal expansion between the metal adapter and the ceramic adapter.

Example 13 is an assembly as in any combination of any of Examples 1-12, wherein the sealant comprises a glass sealant.

Example 14 is an assembly as in any combination of any of Examples 1-13, wherein the sealant comprises a glass-ceramic sealant.

Example 15 is an assembly as in any combination of any of Examples 1-14, wherein the sealant comprises a compliant metallic layer.

Example 16 is an assembly as in any combination of any of Examples 1-15, wherein the metal adapter is constructed of a stainless steel 446.

Example 17 is an assembly as in any combination of any of Examples 1-16, further comprising an electrochemical stack, wherein the electrochemical stack comprises: a plurality of ceramic wafers; a plurality of electrically conductive interconnects disposed in between adjacent pairs of ceramic wafers of the plurality of ceramic wafers; and a terminal plate, wherein the ceramic adapter is attached to the terminal plate.

Example 18 is an assembly as in any combination of any of Examples 1-17, wherein each of the plurality of ceramic wafers comprises: an anode cap; a porous anode; an electrolyte; and a porous cathode; wherein oxygen ions pass through a crystalline structure of the electrolyte such that the electrochemical stack outputs purified oxygen gas.

Example 19 is an assembly as in any combination of any of Examples 1-18, wherein each of the plurality of ceramic wafers further comprises a spacer; wherein the spacer is attached to the electrolyte; and wherein the spacer is manufactured separately from the anode cap, the porous anode, the electrolyte, and the porous cathode.

Example 20 is an assembly as in any combination of any of Examples 1-19, wherein the anode cap, the electrolyte, and the spacer each comprise closed porosity.

Example 21 is an assembly as in any combination of any of Examples 1-20, wherein the ceramic adapter comprises closed porosity such that the ceramic adapter is sufficiently nonporous to prevent molecular diffusion across the ceramic adapter.

Example 22 is an assembly as in any combination of any of Examples 1-21, wherein the assembly comprises: a first ceramic wafer comprising a porous cathode; a second ceramic wafer comprising an anode cap; and an interconnect disposed in between the first ceramic wafer and the second ceramic wafer. The assembly is such that the interconnect is attached to the porous cathode of the first ceramic wafer and is further attached to the anode cap of the second ceramic wafer. The assembly is such that the interconnect comprises a through-porosity that enables an oxygen-containing gas to pass through the interconnect or diffuse into the interconnect.

Example 23 is an assembly as in any combination of any of Examples 1-22, wherein the interconnect comprises from about 5 vol. % to about 80 vol. % an electrically conductive metal.

Example 24 is an assembly as in any combination of any of Examples 1-23, wherein the electrically conductive metal comprises one or more of silver, gold, platinum, palladium, nickel, ruthenium, or rhodium.

Example 25 is an assembly as in any combination of any of Examples 1-24, wherein the interconnect further comprises from about 20 vol. % to about 90 vol. % a partially or wholly sintered ceramic powder.

Example 26 is an assembly as in any combination of any of Examples 1-25, wherein the interconnect comprises from about 20 vol. % to about 100 vol. % a partially or wholly sintered ceramic powder.

Example 27 is an assembly as in any combination of any of Examples 1-26, wherein the interconnect comprises an open porosity from about 25 percent to about 60 percent.

Example 28 is an assembly as in any combination of any of Examples 1-27, wherein the interconnect comprises an open porosity of at least five percent porosity.

Example 29 is an assembly as in any combination of any of Examples 1-28, wherein the interconnect comprises a resistance less than or equal to five milliohms.

Example 30 is an assembly as in any combination of any of Examples 1-29, wherein each of the first ceramic wafer and the second ceramic wafer comprises a planar geometry within a manufacturing tolerance threshold permitting a warping up to 500 micrometers across a surface of the first ceramic wafer or the second ceramic wafer.

Example 31 is an assembly as in any combination of any of Examples 1-30, wherein each of the first ceramic wafer and the second ceramic wafer comprises: an anode cap, wherein the anode cap comprises closed porosity; a porous anode; an electrolyte comprising closed porosity; a porous cathode; and an anode edge attached to the porous anode, wherein the anode edge comprises closed porosity.

Example 32 is an assembly as in any combination of any of Examples 1-31, wherein the electrolyte permits diffusion of oxygen ions across a thickness of the electrolyte.

Example 33 is an assembly as in any combination of any of Examples 1-32, wherein each of the first ceramic wafer and the second ceramic wafer comprises a through-hole, and

wherein a first through-hole of the first ceramic wafer is aligned with a second through-hole of the second ceramic wafer to enable purified oxygen gas to pass through the first through-hole and the second through-hole.

Example 34 is an assembly as in any combination of any of Examples 1-33, wherein the interconnect further comprises a sintering aid that lowers a sintering temperature of the interconnect, and wherein the sintering aid comprises one or more of cobalt, copper, nickel, manganese, or iron.

Example 35 is an assembly as in any combination of any of Examples 1-34, wherein the interconnect comprises from about 0.25 vol. % to about 5 vol. % the sintering aid.

Example 36 is an assembly as in any combination of any of Examples 1-35, wherein the interconnect facilitates electrical communication between the first ceramic wafer and the second ceramic wafer.

Example 37 is an assembly as in any combination of any of Examples 1-36, further comprising an electrochemical stack comprising at least the first ceramic wafer and the second ceramic wafer, wherein the interconnect is a current carrier facilitating electrical communication between the first ceramic wafer and the second ceramic wafer in response to a direct current voltage being applied to the electrochemical stack.

Example 38 is an assembly as in any combination of any of Examples 1-37, further comprising a spacer disposed in between the first ceramic wafer and the second ceramic wafer to create a gap in between the first ceramic wafer and the second ceramic wafer, and wherein the spacer comprises closed porosity.

Example 39 is an assembly as in any combination of any of Examples 1-38, wherein the interconnect comprises a height sufficient to bridge the gap in between the first ceramic wafer and the second ceramic wafer.

Example 40 is an assembly as in any combination of any of Examples 1-39, wherein each of the first ceramic wafer and the second ceramic wafer comprises a geometry comprising four or more sides, and wherein at least one of the four or more sides is a longest side; and wherein the interconnect comprises a line geometry extending substantially perpendicular to the longest side of the four or more sides of the first ceramic wafer and the second ceramic wafer.

Example 41 is an assembly as in any combination of any of Examples 1-40, wherein each of the first ceramic wafer and the second ceramic wafer comprises a geometry comprising four or more sides, and wherein at least one of the four or more sides is a longest side; wherein each of the first ceramic wafer and the second ceramic wafer comprises a through-hole disposed substantially in a center of the first ceramic wafer and the second ceramic wafer; wherein the interconnect comprises a bent line geometry that comprises: a middle portion extending substantially perpendicular to the longest side of the four or more sides of the first ceramic wafer and the second ceramic wafer; a first bent portion; and a second bent portion; and wherein the bent line geometry is oriented to wrap at least partially around the through-hole.

Example 42 is an assembly as in any combination of any of Examples 1-41, wherein each of the first ceramic wafer and the second ceramic wafer comprises a quadrilateral geometry, and wherein the quadrilateral geometry comprises four chamfered or rounded corners.

Example 43 is an assembly as in any combination of any of Examples 1-42, wherein the assembly comprises: a first ceramic wafer; a second ceramic wafer; and a ceramic spacer disposed in between the first ceramic wafer and the second ceramic wafer; wherein the ceramic spacer is attached to the first ceramic wafer with a first glass-ceramic seal, and the ceramic spacer is attached to the second ceramic wafer with a second glass-ceramic seal; and wherein at least one of the first glass-ceramic seal or the second glass-ceramic seal is a gastight seal after undergoing two or more sintering cycles.

Example 44 is an assembly as in any combination of any of Examples 1-43, wherein the second ceramic wafer comprises an anode cap, and wherein the second glass-ceramic seal attaching the ceramic spacer to the second ceramic wafer is formed in between the ceramic spacer and the anode cap of the second ceramic wafer.

Example 45 is an assembly as in any combination of any of Examples 1-44, wherein the ceramic spacer comprises: a first end, wherein the first end is attached to the first ceramic wafer; a second end, wherein the second end is attached to the second ceramic wafer; and an exposed portion, wherein the exposed portion is disposed in between the first ceramic wafer and the second ceramic wafer and defines a gap in between the first ceramic wafer and the second ceramic wafer.

Example 46 is an assembly as in any combination of any of Examples 1-45, wherein the first ceramic wafer comprises: a first anode cap, a first anode, a first electrolyte, and a first cathode; and wherein the second ceramic wafer comprises: a second anode cap, a second anode, a second electrolyte, and a second cathode.

Example 47 is an assembly as in any combination of any of Examples 1-46, wherein the first ceramic wafer comprises a first through-hole disposed therethrough, and wherein the first through-hole comprises: an electrolyte-anode portion comprising an electrolyte-anode radius, wherein the electrolyte-anode portion extends through each of the first anode cap, the first anode, and the first electrolyte; and a cathode portion comprising a cathode radius, wherein the cathode portion extends through the first cathode; wherein a length of the electrolyte-anode radius is smaller than a length of the cathode-radius.

Example 48 is an assembly as in any combination of any of Examples 1-47, wherein the ceramic spacer comprises a sidewall defining a hollow cylindrical geometry that comprises an exterior radius and an interior radius; and wherein a length of the interior radius of the ceramic spacer is greater than or equal to the length of the electrolyte-anode radius of the first ceramic wafer.

Example 49 is an assembly as in any combination of any of Examples 1-48, wherein the ceramic spacer comprises a sidewall defining a hollow cylindrical geometry that comprises an exterior radius and an interior radius; and wherein a length of the exterior radius of the ceramic spacer is less than or equal to the length of the cathode radius of the first ceramic wafer.

Example 50 is an assembly as in any combination of any of Examples 1-49, wherein the ceramic spacer comprises a sidewall defining a hollow cylindrical geometry that comprises an exterior radius and an interior radius; and wherein a length of the interior radius of the ceramic spacer is greater than or equal to the length of the electrolyte-anode radius of the first ceramic wafer; wherein a length of the exterior radius of the ceramic spacer is less than or equal to the length of the cathode radius of the first ceramic wafer; and wherein the first through-hole of the first ceramic wafer and the interior of the hollow cylindrical geometry of the ceramic spacer form a continuous port for outputting purified oxygen gas.

Example 51 is an assembly as in any combination of any of Examples 1-50, wherein the ceramic spacer comprises closed porosity.

Example 52 is an assembly as in any combination of any of Examples 1-51, further comprising an interconnect disposed in between the first ceramic wafer and the second ceramic wafer, wherein the interconnect facilitates electrical communication between the first ceramic wafer and the second ceramic wafer.

Example 53 is an assembly as in any combination of any of Examples 1-52, wherein the ceramic spacer is manufactured independently from the first ceramic wafer and the second ceramic wafer.

Example 54 is an assembly as in any combination of any of Examples 1-53, wherein one or more of the first glass-ceramic seal or the second glass-ceramic seal is a fully devitrified seal.

Example 55 is an assembly as in any combination of any of Examples 1-54, wherein one or more of the first glass-ceramic seal or the second glass-ceramic seal comprises lithium oxide, silicon dioxide, and aluminum oxide.

Example 56 is an assembly as in any combination of any of Examples 1-55, wherein one or more of the first glass-ceramic seal or the second glass-ceramic seal comprises silicon oxide, calcium oxide, and magnesium oxide.

Example 57 is an assembly as in any combination of any of Examples 1-56, wherein one or more of the first glass-ceramic seal or the second glass-ceramic seal comprises one or more of potassium oxide, boron oxide, phosphorus pentoxide, sodium oxide, or barium oxide.

Example 58 is an assembly as in any combination of any of Examples 1-57, wherein one or more of the first glass-ceramic seal or the second glass-ceramic seal comprises a lithia-alumina-silica seal.

Example 59 is an assembly as in any combination of any of Examples 1-58, wherein a thickness of one or more of the first glass-ceramic seal or the second glass-ceramic seal is customizable to compensate for a manufacturing tolerance introducing a non-flat portion in any of the first ceramic wafer, the second ceramic wafer, or the ceramic spacer.

Example 60 is an assembly as in any combination of any of Examples 1-59, wherein the ceramic spacer is sealed to the first ceramic wafer and the second ceramic wafer in response to determining each of the first ceramic wafer and the second ceramic wafer is gastight.

Example 61 is an assembly as in any combination of any of Examples 1-60, wherein each of the first ceramic wafer and the second ceramic wafer comprises a plurality of ceramic layers configured to transport oxygen ions and output purified oxygen gas.

Example 62 is an assembly as in any combination of any of Examples 1-61, wherein the terminal plumbing assembly comprises: the ceramic adapter, wherein at least a portion of the ceramic adapter comprises a frustrum geometry; the metal adapter comprising the sidewall, wherein the sidewall defines a hollow cylindrical geometry; and the adapter skirt attached to the metal adapter; wherein the adapter skirt receives the ceramic adapter; and wherein a sealant is disposed in between an exterior surface of the ceramic adapter and an interior surface of the adapter skirt.

Example 63 is an assembly as in any combination of any of Examples 1-62, wherein the ceramic spacer is attached to the first ceramic wafer with a first glass-ceramic seal, and the ceramic spacer is attached to the second ceramic wafer with a second glass-ceramic seal; and wherein at least one of the first glass-ceramic seal or the second glass-ceramic seal is a gastight seal after undergoing two or more sintering cycles.

Example 64 is an assembly as in any combination of any of Examples 1-63, wherein the interconnect is sealed to a porous cathode layer of the first ceramic wafer and is further sealed to an anode cap layer of the second ceramic wafer; and wherein the interconnect comprises from about 5 vol. % to about 80 vol. % an electrically conductive metal.

Example 65 is an assembly as in any combination of any of Examples 1-64, wherein the plurality of wafers of the electrochemical stack output the purified oxygen gas by transporting oxygen ions across at least a portion of the plurality of wafers in response to the electrochemical stack being supplied with an electrical potential.

Example 66 is an assembly as in any combination of any of Examples 1-65, wherein the interconnect carries current in between the first ceramic wafer and the second ceramic wafer in response to the electrochemical stack being supplied with the electrical potential.

Example 67 is an assembly as in any combination of any of Examples 1-66, wherein the interconnect comprises a through-porosity that enables an oxygen-containing gas to pass through the interconnect or diffuse into the interconnect.

Example 68 is an assembly as in any combination of any of Examples 1-67, wherein each of the plurality of wafers of the electrochemical stack comprises: an anode cap that is sufficiently nonporous to prevent molecular diffusion across the anode cap; a porous anode; an electrolyte that is sufficiently nonporous to prevent molecular diffusion across the electrolyte; and a porous cathode.

Example 69 is an assembly as in any combination of any of Examples 1-68, wherein the ceramic spacer is attached to a first electrolyte of the first ceramic wafer and a second anode cap of the second ceramic wafer.

Example 70 is an assembly as in any combination of any of Examples 1-69, wherein an exposed portion of the ceramic spacer is disposed in between the first ceramic wafer and the second ceramic wafer to define a gap in between the first ceramic wafer and the second ceramic wafer.

Example 71 is an assembly as in any combination of any of Examples 1-70, wherein each of the first ceramic wafer and the second ceramic wafer comprises a through-hole; wherein the ceramic spacer comprises a sidewall defining a hollow cylindrical geometry; and wherein a first through-hole of the first ceramic wafer is aligned with a second through-hole of the second ceramic wafer, and is further aligned with an internal hole defined by the sidewall of the ceramic spacer to collectively form an exhaust port through the electrochemical stack.

Example 72 is an assembly as in any combination of any of Examples 1-71, wherein the metal tube is in fluid communication with the electrochemical stack such that the purified oxygen gas is output through the exhaust port of the electrochemical stack and is further output through the metal tube.

Example 73 is an assembly as in any combination of any of Examples 1-72, wherein the interconnect comprises from about 30 vol. % to about 70 vol. % a ceramic powder.

Example 74 is an assembly as in any combination of any of Examples 1-73, wherein the interconnect comprises a resistance less than or equal to one ohm.

Example 75 is an assembly as in any combination of any of Examples 1-74, wherein the terminal plumbing assembly further comprises an adapter skirt attached to the metal adapter, and wherein the adapter skirt comprises a hollow frustrum geometry such that the adapter skirt comprises: an upper circular base comprising an upper radius; and a lower circular base comprising a lower radius; wherein the lower radius is longer than the upper radius.

Example 76 is an assembly as in any combination of any of Examples 1-75, wherein the adapter skirt extends outward relative to the sidewall of the metal adapter to define an exterior skirt angle; wherein the exterior skirt angle is defined by a first ray running parallel to the sidewall of the metal adapter, and a second ray running parallel to an exterior surface of the adapter skirt; and wherein the exterior skirt angle is from about 95° to about 170°.

Example 77 is an assembly as in any combination of any of Examples 1-76, wherein the terminal plumbing assembly comprises a secondary seal disposed on at least a portion of interior surfaces and exterior surfaces of the metal adapter and an adapter skirt that is attached to the metal adapter; and wherein the secondary seal comprises a glass seal.

Example 78 is an assembly as in any combination of any of Examples 1-77, wherein the ceramic spacer is sufficiently nonporous to prevent molecular diffusion through the ceramic spacer.

Example 79 is an assembly as in any combination of any of Examples 1-78, wherein the ceramic spacer is attached to the first ceramic wafer with a first glass-ceramic seal, and the ceramic spacer is attached to the second ceramic wafer with a second glass-ceramic seal; and wherein one or more of the first glass-ceramic seal or the second glass-ceramic seal is a fully devitrified seal.

Example 80 is an assembly as in any combination of any of Examples 1-79, wherein the ceramic spacer is attached to the first ceramic wafer with a first glass-ceramic seal, and the ceramic spacer is attached to the second ceramic wafer with a second glass-ceramic seal; and wherein one or more of the first glass-ceramic seal or the second glass-ceramic seal comprises one or more of lithium oxide, silicon dioxide, aluminum oxide, potassium oxide, boron oxide, or phosphorus pentoxide.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. An assembly comprising:
a first ceramic wafer comprising a porous cathode;
a second ceramic wafer comprising an anode cap; and
an interconnect disposed in between the first ceramic wafer and the second ceramic wafer;
wherein the interconnect is attached to the porous cathode of the first ceramic wafer and is further attached to the anode cap of the second ceramic wafer; and
wherein the interconnect comprises a through-porosity that enables an oxygen-containing gas to pass through the interconnect or diffuse into the interconnect.

2. The assembly of claim 1, wherein the interconnect comprises from about 5 vol. % to about 80 vol. % an electrically conductive metal.

3. The assembly of claim 1, wherein the electrically conductive metal comprises one or more of silver, gold, platinum, palladium, nickel, ruthenium, or rhodium.

4. The assembly of claim 1, wherein the interconnect further comprises from about 20 vol. % to about 90 vol. % a partially or wholly sintered ceramic powder.

5. The assembly of claim 1, wherein the interconnect comprises from about 20 vol. % to about 100 vol. % a partially or wholly sintered ceramic powder.

6. The assembly of claim 1, wherein the interconnect comprises an open porosity from about 25 percent to about 60 percent.

7. The assembly of claim 1, wherein the interconnect comprises an open porosity of at least five percent porosity.

8. The assembly of claim 1, wherein the interconnect comprises a resistance less than or equal to five milliohms.

9. The assembly of claim 1, wherein each of the first ceramic wafer and the second ceramic wafer comprises a planar geometry within a manufacturing tolerance threshold permitting a warping up to 500 micrometers across a surface of the first ceramic wafer or the second ceramic wafer.

10. The assembly of claim 1, wherein each of the first ceramic wafer and the second ceramic wafer comprises:
an anode cap, wherein the anode cap comprises closed porosity;
a porous anode;
an electrolyte comprising closed porosity;
a porous cathode; and
an anode edge attached to the porous anode, wherein the anode edge comprises closed porosity.

11. The system of claim 10, wherein the electrolyte permits diffusion of oxygen ions across a thickness of the electrolyte.

12. The assembly of claim 1, wherein each of the first ceramic wafer and the second ceramic wafer comprises a through-hole, and wherein a first through-hole of the first ceramic wafer is aligned with a second through-hole of the second ceramic wafer to enable purified oxygen gas to pass through the first through-hole and the second through-hole.

13. The assembly of claim 1, wherein the interconnect further comprises a sintering aid that lowers a sintering temperature of the interconnect, and wherein the sintering aid comprises one or more of cobalt, copper, nickel, manganese, or iron.

14. The assembly of claim 13, wherein the interconnect comprises from about 0.25 vol. % to about 5 vol. % the sintering aid.

15. The assembly of claim 1, wherein the interconnect facilitates electrical communication between the first ceramic wafer and the second ceramic wafer.

16. The assembly of claim 1, further comprising an electrochemical stack comprising at least the first ceramic wafer and the second ceramic wafer, wherein the interconnect is a current carrier facilitating electrical communication between the first ceramic wafer and the second ceramic wafer in response to a direct current voltage being applied to the electrochemical stack.

17. The assembly of claim 1, further comprising a spacer disposed in between the first ceramic wafer and the second ceramic wafer to create a gap in between the first ceramic wafer and the second ceramic wafer, and wherein the spacer comprises closed porosity.

18. The assembly of claim 17, wherein the interconnect comprises a height sufficient to bridge the gap in between the first ceramic wafer and the second ceramic wafer.

19. The assembly of claim 1, wherein each of the first ceramic wafer and the second ceramic wafer comprises a geometry comprising four or more sides, and wherein at least one of the four or more sides is a longest side; and
wherein the interconnect comprises a line geometry extending substantially perpendicular to the longest side of the four or more sides of the first ceramic wafer and the second ceramic wafer.

20. The assembly of claim 1, wherein each of the first ceramic wafer and the second ceramic wafer comprises a geometry comprising four or more sides, and wherein at least one of the four or more sides is a longest side;
wherein each of the first ceramic wafer and the second ceramic wafer comprises a through-hole disposed substantially in a center of the first ceramic wafer and the second ceramic wafer;
wherein the interconnect comprises a bent line geometry that comprises:
a middle portion extending substantially perpendicular to the longest side of the four or more sides of the first ceramic wafer and the second ceramic wafer;
a first bent portion; and
a second bent portion; and
wherein the bent line geometry is oriented to wrap at least partially around the through-hole.

21. The assembly of claim 1, wherein each of the first ceramic wafer and the second ceramic wafer comprises a quadrilateral geometry, and wherein the quadrilateral geometry comprises four chamfered or rounded corners.
